(19) United States
(12) Patent Application Publication
(10) Pub. No.: US 2022/0372271 A1
(43) Pub. Date: Nov. 24, 2022

(54) COMPOSITION, CURABLE COMPOSITION, CURED PRODUCT, AND STORAGE METHOD

(71) Applicant: KANEKA CORPORATION, Osaka (JP)

(72) Inventors: Kazuhiko Hirabayashi, Osaka (JP); Jiro Okai, Hyogo (JP); Taisuke Sasaki, Ibaraki (JP); Kenichi Yoshihashi, Osaka (JP)

(73) Assignee: KANEKA CORPORATION, Osaka (JP)

(21) Appl. No.: 17/879,046

(22) Filed: Aug. 2, 2022

Related U.S. Application Data
(63) Continuation of application No. PCT/JP2021/003809, filed on Feb. 3, 2021.

(30) Foreign Application Priority Data
Feb. 4, 2020 (JP) 2020-017358

(51) Int. Cl. C08L 53/00; C09J 153/00; C09K 3/10

(52) U.S. Cl. CPC C08L 53/00; C09J 153/00; C09K 3/10; C09K 2200/0642; C09K 2200/0647; C08L 2205/06

(57) ABSTRACT

A composition with improved storage viscosity is provided. The composition contains a (meth)acrylic-based copolymer (A′) and an epoxy compound (C). A molecule of the (meth)acrylic-based copolymer (A′) includes an XY diblock structure or an XYX triblock structure therein. A number of repeating units which are derived from a (meth)acrylic ester monomer having an alkoxysilyl group and are included in an X block is 1.0 or more on average; an amount of repeating units which are derived from a (meth)acrylic ester monomer having an alkoxysilyl group and are included in a Y block is 0% by weight to 3% by weight, with respect to a weight of all repeating units included in the Y block. A molecular weight distribution (Mw/Mn) of the (meth)acrylic-based copolymer (A′) is 1.8 or less.

### TECHNICAL FIELD

One or more embodiments of the present invention relate to a composition, a curable composition, a cured product, and a storage method.

### BACKGROUND

A polymer molecule having an alkoxysilyl group forms, by hydrolysis of the alkoxysilyl group, a siloxane bond with another polymer molecule. Then, it is known that a rubbery cured product is obtained by this crosslinking reaction. With use of this feature, polymers having an alkoxysilyl group are used in a wide variety of applications such as a sealing material, an adhesive agent, and paint.

Patent Literature 1 discloses a method for producing a (meth)acrylic-based copolymer having an alkoxysilyl group, which is an example of such a polymer, by atom transfer radical polymerization. This method includes the following three steps.

(1) A first step of polymerizing an initiator having one halogen group in a molecule, a (meth)acrylic monomer (B) having a hydrolyzable silyl group, and a (meth)acrylic monomer (C) having no hydrolyzable silyl group to synthesize a macroinitiator.

(2) A second step of adding a (meth)acrylic monomer (C) to synthesize an intermediate polymer.

(3) A third step of adding a (meth)acrylic monomer (B) to synthesize an intermediate polymer.

### PATENT LITERATURE

[Patent Literature 1]

Japanese Patent Application Publication Tokukai No. 2018-162394

According to the production method disclosed in Patent Literature 1, it is possible to produce a (meth)acrylic-based copolymer having an alkoxysilyl group with higher productivity than conventional production methods. However, there has been room for improving viscosity of a polymer in such a (meth)acrylic-based copolymer produced by the production method. Specifically, the viscosity (storage viscosity) of the copolymer becomes high after storage at high temperature.

### SUMMARY

An aspect of one or more embodiments of the present invention provides a composition having improved storage viscosity.

A composition in accordance with an aspect of one or more embodiments of the present invention is a composition containing a (meth)acrylic-based copolymer (A′) and an epoxy compound (C), in which:

the (meth)acrylic-based copolymer (A′) has an X block and a Y block;

a molecule of the (meth)acrylic-based copolymer (A′) includes an XY diblock structure or an XYX triblock structure therein;

the number of repeating units which are derived from a (meth)acrylic ester monomer having an alkoxysilyl group and are included in the X block is 1.0 or more on average;

an amount of repeating units which are derived from a (meth)acrylic ester monomer having an alkoxysilyl group and are included in the Y block is 0% by weight to 3% by weight, with respect to a weight of all repeating units included in the Y block; and

a molecular weight distribution (Mw/Mn) of the (meth)acrylic-based copolymer (A′) is 1.8 or less.

According to an aspect of one or more embodiments of the present invention, it is possible to provide a composition having improved storage viscosity.

### DETAILED DESCRIPTION

The following description will discuss an example of one or more embodiments of the present invention in detail. One or more embodiments of the present invention is, however, not limited to the embodiments.

Note that the expression “A to B”, representing a numerical range, herein means “not less than A and not more than B” unless otherwise specified in the present disclosure. In the present disclosure, the term “(meth)acryl” refers to “acryl” and/or “methacryl”.

The composition in accordance with an aspect of one or more embodiments of the present invention contains a (meth)acrylic-based copolymer (A′) and an epoxy compound (C). In one embodiment, the (meth)acrylic-based copolymer (A′) is a (meth)acrylic-based copolymer (A″).

[1. (Meth)Acrylic-Based Copolymer (A′) and (Meth)Acrylic-Based Copolymer (A″)]

The composition in accordance with an aspect of one or more embodiments of the present invention contains a (meth)acrylic-based copolymer (A′). The (meth)acrylic-based copolymer (A′) has an X block and a Y block. A molecule of the (meth)acrylic-based copolymer (A′) includes an XY diblock structure or an XYX triblock structure therein. An entire molecular structure of the (meth)acrylic-based copolymer (A′) is not particularly limited as long as the XY diblock structure or the XYX triblock structure is included, and can be, for example, an XYXY tetrablock structure.

Here, the “XYX triblock structure” means an “ABA triblock structure” commonly referred to by those skilled in the art. A ratio of X/Y in the (meth)acrylic-based copolymer (A′) may be (5/95) to (60/40), or (15/85) to (40/60).

In one embodiment, a molecule of the (meth)acrylic-based copolymer (A′) has the XY diblock structure. In a molecule having the XY diblock structure, the X block can be a region of 40% or less, 30% or less, or 25% or less from one end of the molecule (where all units included in the molecule are regarded as 100%). Here, the X block is a block on the side where alkoxysilyl groups are relatively more distributed.

In one embodiment, a molecule of the (meth)acrylic-based copolymer (A′) has the XYX triblock structure. In a molecule having the XYX triblock structure, the X block can be a region of 40% or less, 30% or less, or 25% or less from each end of the molecule (where all units included in the molecule are regarded as 100%). Here, the X block is blocks located at both ends of the molecule.

The (meth)acrylic-based copolymer (A′) has repeating units derived from a (meth)acrylic ester monomer having an alkoxysilyl group. The repeating units derived from the (meth)acrylic ester monomer having the alkoxysilyl group are included relatively more in the X block. Specifically, the number of repeating units which are derived from a (meth)acrylic ester monomer having an alkoxysilyl group and are included in the X block is 1.0 or more on average. Meanwhile, an amount of repeating units which are derived from a (meth)acrylic ester monomer having an alkoxysilyl group and are included in the Y block is 0% by weight to 3% by weight, with respect to a weight of all repeating units included in the Y block.

Thus, the repeating units derived from the (meth)acrylic ester monomer having the alkoxysilyl group are distributed more in at least one end part of the (meth)acrylic-based copolymer (A′). In particular, in a case where the (meth)acrylic-based copolymer (A′) takes the XY diblock structure, the repeating units derived from the (meth)acrylic ester monomer having the alkoxysilyl group are localized at one end of the molecule. In a case where the (meth)acrylic-based copolymer (A′) takes the XYX triblock structure, the repeating units derived from the (meth)acrylic ester monomer having the alkoxysilyl group are localized at both ends of the molecule.

The number of the repeating units which are derived from the (meth)acrylic ester monomer having the alkoxysilyl group and are included in the X block may be 1.5 or more, or 1.7 or more, on average. Similarly, an amount of the repeating units which are derived from the (meth)acrylic ester monomer having the alkoxysilyl group and are included in the X block may be more than 3% by weight, not less than 4.5% by weight, or not less than 5% by weight, with respect to a weight of all repeating units included in the X block. An upper limit of the repeating units which are derived from the (meth)acrylic ester monomer having the alkoxysilyl group and are included in the Y block may be not more than 2% by weight, or not more than 1% by weight, with respect to a weight of all repeating units included in the Y block. A lower limit of the repeating units which are derived from the (meth)acrylic ester monomer having the alkoxysilyl group and are included in the Y block may be more than 0% by weight, or not less than 0% by weight, with respect to a weight of all repeating units included in the Y block.

The (meth)acrylic-based copolymer (A′) is an acrylic-based copolymer having a small ratio between a weight-average molecular weight (Mw) and a number-average molecular weight (Mn) (Mw/Mn; molecular weight distribution). The molecular weight distribution of the (meth)acrylic-based copolymer (A′) is 1.8 or less. The molecular weight distribution of the (meth)acrylic-based copolymer (A′) may be 1.7 or less, 1.6 or less, 1.5 or less, 1.4 or less, or 1.3 or less. If the molecular weight distribution is too large, viscosity of the polymer increases, and workability tends to decrease.

The weight-average molecular weight and the number-average molecular weight can be measured, for example, by gel permeation chromatography (GPC). For GPC measurement, chloroform can be used as a mobile phase, and a polystyrene gel column can be used as a stationary phase. Further, those molecular weights can be calculated in terms of polystyrene.

Thus, the (meth)acrylic-based copolymer (A′) having a small molecular weight distribution can be suitably produced, for example, by a production method utilizing living radical polymerization. More suitably, the (meth)acrylic-based copolymer (A′) can be produced by a method described in Section [2].

((Meth)Acrylic-Based Copolymer (A″)

In one embodiment, the (meth)acrylic-based copolymer (A′) is a (meth)acrylic-based copolymer (A″). The (meth)acrylic-based copolymer (A″) is a particularly preferable embodiment in that viscosity (initial viscosity) immediately after production is lowered. The (meth)acrylic-based copolymer (A″) randomly includes repeating units derived from a (meth)acrylic ester monomer (α). The repeating units derived from the (meth)acrylic ester monomer (α) are included in an amount of 5% by weight to 20% by weight, with respect to a weight of all repeating units included in the (meth)acrylic-based copolymer (A″) (there is a critical significance in this contained amount). Here, the (meth)acrylic ester monomer (α) is a monomer which has an alkyl group coupled to (meth)acrylic acid via an ester bond, and in which the alkyl group has an alkoxy group having 1 to 5 carbon atoms. Preferably, the number of carbon atoms of the alkyl group coupled to the acrylic acid via an ester bond is 1 to 5.

A contained amount of the repeating units derived from the (meth)acrylic ester monomer (α) may be 10% by weight to 20% by weight, with respect to a weight of all repeating units included in the (meth)acrylic-based copolymer (A″).

In a case where the repeating units derived from the (meth)acrylic ester monomer (α) are randomly included and the contained amount thereof is within the range described above, initial viscosity of the (meth)acrylic-based copolymer (A″) can be lowered. The initial viscosity of the (meth)acrylic-based copolymer (A″) may be 200 Pa·s or less, 150 Pa·s or less, or 130 Pa·s or less. The initial viscosity can be measured with a suitable viscometer. Note that the term “initial viscosity” in this specification refers to viscosity of the (meth)acrylic-based copolymer (A″) seen after the (meth)acrylic-based copolymer (A″) is produced and then stored at room temperature within half a year.

In addition, in a case where the contained amount of the repeating units derived from the (meth)acrylic ester monomer (α) is within the above range, compatibility between the (meth)acrylic-based polymer (A) and the polyoxyalkylene-based polymer (B) becomes high. It is therefore possible to obtain a curable composition and a cured product having good properties.

[1.1. (Meth)Acrylic Ester Monomer]

The (meth)acrylic-based copolymer (A′) includes in its main chain constitutional units derived from a (meth)acrylic ester monomer. The (meth)acrylic ester monomer constituting the main chain is not particularly limited as long as the above described requirements are satisfied. Only one type of the (meth)acrylic ester monomer can be used, or two or more types of the (meth)acrylic ester monomers can be used in combination.

Types of such (meth)acrylic ester monomers include the following monomers.
(Meth)acrylic ester monomer (α): A monomer which has an alkyl group coupled to (meth)acrylic acid via an ester bond, and in which the alkyl group has an alkoxy group having 1 to 5 carbon atoms.
(Meth)acrylic ester monomer (β): A monomer in which an alkyl group coupled to (meth)acrylic acid via an ester bond has 1 to 5 carbon atoms.
(Meth)acrylic ester monomer (γ): A monomer in which an alkyl group coupled to (meth)acrylic acid via an ester bond has 6 to 15 carbon atoms.
(Meth)acrylic ester monomer (δ): A monomer in which an alkyl group coupled to (meth)acrylic acid via an ester bond has 16 to 25 carbon atoms.

In the (meth)acrylic-based copolymer (A′), a contained amount of repeating units derived from the (meth)acrylic ester monomer (α) may be 0% by weight to 20% by weight, with respect to a weight of all repeating units included in the (meth)acrylic-based copolymer (A′). A total contained amount of repeating units derived from the (meth)acrylic ester monomer (β) and the (meth)acrylic acid monomer (γ) may be 45% by weight to 96% by weight, with respect to a weight of all repeating units included in the (meth)acrylic-based copolymer (A′). A contained amount of repeating units derived from the (meth)acrylic ester monomer (δ) may be 4% by weight to 35% by weight, with respect to a weight of all repeating units included in the (meth)acrylic-based copolymer (A′). By containing each of the (meth)acrylic ester monomers with such a composition, the (meth)acrylic-based copolymer (A′) can obtain good workability, mechanical properties, and weather resistance.

Among (meth)acrylic-based copolymers (A′), in the (meth)acrylic-based copolymer (A″), a contained amount of repeating units derived from the (meth)acrylic ester monomer (α) is 5% by weight to 20% by weight, preferably 10% by weight to 20% by weight, with respect to a weight of all repeating units included in the (meth)acrylic-based copolymer (A″). A contained amount of repeating units derived from the (meth)acrylic ester monomer (β) may be 45% by weight to 70% by weight, or 50% by weight to 70% by weight, with respect to a weight of all repeating units included in the (meth)acrylic-based copolymer (A″). A contained amount of repeating units derived from the (meth)acrylic ester monomer (γ) may be 0% by weight to 25% by weight, or 10% by weight to 25% by weight, with respect to a weight of all repeating units included in the (meth)acrylic-based copolymer (A″). A contained amount of repeating units derived from the (meth)acrylic ester monomer (δ) may be 15% by weight to 25% by weight, or 15% by weight to 20% by weight, with respect to a weight of all repeating units included in the (meth)acrylic-based copolymer (A″). By containing each of the (meth)acrylic ester monomers with such a composition, the (meth)acrylic-based copolymer (A″) can obtain good workability, mechanical properties, and weather resistance.

In a case where the contained amount of the repeating units derived from the (meth)acrylic ester monomer (β) is within the above range, compatibility between the (meth)acrylic-based polymer (A′) and the polyoxyalkylene-based polymer (B) can be sufficiently secured. In a case where the contained amount of the repeating units derived from the (meth)acrylic ester monomer (γ) is within the above range, it is possible to prevent an increase in viscosity at a low temperature and to prevent a decrease in workability. In a case where the contained amount of the repeating units derived from the (meth)acrylic ester monomer (γ) is within the above range, compatibility between the (meth)acrylic-based polymer (A′) and the polyoxyalkylene-based polymer (B) can be sufficiently secured. In a case where the contained amount of the repeating units derived from the (meth)acrylic ester monomer (δ) is within the above range, compatibility between the (meth)acrylic-based polymer (A′) and the polyoxyalkylene-based polymer (B) can be sufficiently secured. In a case where the contained amount of the repeating units derived from the (meth)acrylic ester monomer (δ) is within the above range, it is possible to prevent an increase in viscosity at a low temperature and to prevent a decrease in workability.

The (meth)acrylic ester monomer is not particularly limited, and conventionally known ones can be used. Examples of the (meth)acrylic ester monomer (α) include 2-methoxyethyl (meth)acrylate, 2-ethoxyethyl (meth)acrylate, 2-butoxyethyl (meth)acrylate, and isopropoxyethyl (meth)acrylate. Examples of the (meth)acrylic ester monomer (β) include methyl (meth)acrylate, ethyl (meth)acrylate, n-propyl (meth)acrylate, n-butyl (meth)acrylate, isobutyl (meth)acrylate, and tert-butyl (meth)acrylate. Examples of the (meth)acrylic ester monomer (γ) include n-hexyl (meth)acrylate, heptyl (meth)acrylate, 2-ethylhexyl (meth)acrylate, octyl (meth)acrylate, nonyl (meth)acrylate, decyl (meth)acrylate, undecyl (meth)acrylate, dodecyl (meth)acrylate, tridecyl (meth)acrylate, and tetradecyl (meth)acrylate. Examples of the (meth)acrylic ester monomer (δ) include pentadecyl (meth)acrylate, hexadecyl (meth)acrylate, heptadecyl (meth)acrylate, octadecyl (meth)acrylate, icosyl (meth)acrylate, and docosyl (meth)acrylate.

Among the above described monomers, the (meth)acrylic ester monomer (α) may be one or more selected from the group consisting of 2-methoxyethyl (meth)acrylate, 2-ethoxyethyl (meth)acrylate, 2-butoxyethyl (meth)acrylate, and isopropoxyethyl (meth)acrylate, or 2-methoxyethyl acrylate. As the (meth)acrylic ester monomer (β), butyl acrylate is preferable. As the (meth)acrylic ester monomer (γ), 2-ethylhexyl acrylate and dodecyl acrylate are preferable. The (meth)acrylic ester monomer (δ) may be one or more selected from the group consisting of pentadecyl (meth)acrylate, hexadecyl (meth)acrylate, heptadecyl (meth)acrylate, octadecyl (meth)acrylate, icosyl (meth)acrylate, and docosyl (meth)acrylate, or octadecyl acrylate. By selecting those monomers, the (meth)acrylic-based copolymer (A′) produced can be well-balanced in viscosity, compatibility with the polyoxyalkylene-based polymer (B), weather resistance, mechanical properties, and durability at high levels.

In one embodiment, the (meth)acrylic-based copolymer (A′) does not include repeating units derived from the (meth)acrylic acid monomer (γ). Such a (meth)acrylic-based copolymer (A′) has, for example, units derived from the preferable (meth)acrylic ester monomers (α), (β), and (δ) listed in the above paragraphs. By not including the (meth)acrylic ester monomer (γ) in the raw material, types of raw material monomers to be used can be reduced, and it is therefore possible to reduce a cost and labor of production.

With respect to all repeating units included in the (meth)acrylic-based copolymer (A′), an amount of repeating units derived from the (meth)acrylic ester monomer contained in the (meth)acrylic-based copolymer (A′) may be not less than 70% by weight, or not less than 90% by weight. In a case where the contained amount of the repeating units derived from the (meth)acrylic ester monomer is 70% or more, the (meth)acrylic-based copolymer (A′) to be produced can sufficiently secure compatibility with the polyoxyalkylene-based polymer (B), and also can obtain good weather resistance, mechanical properties, and durability.

[1.2. (Meth)Acrylic Ester Monomer Having Alkoxysilyl Group]

The (meth)acrylic-based copolymer (A′) includes repeating units derived from a (meth)acrylic ester monomer having an alkoxysilyl group. In one embodiment, the alkoxysilyl group is represented by the following general formula (1):

—[Si(R¹)_{2-b}(Y)_{b}O]ₘ—Si(R²)₃₋ₐ(Y)ₐ (1)

In the formula, “R¹” and “R²” are independently an alkyl group having 1 to 20 carbon atoms, an aryl group having 6 to 20 carbon atoms, an aralkyl group having 7 to 20 carbon atoms, a methoxymethyl group, or a triorganosiloxy group represented by (R′)₃SiO— (where “R′” is a monovalent hydrocarbon group having 1 to 20 carbon atoms, and the three R′ groups present can be the same or different). In a case where two or more R¹ or R² groups are present, the R′ or R² groups can be the same or different. “Y” is an alkoxy group having 1 to 20 carbon atoms (in a case where two or more Y groups are present, the Y groups can be the same or different). “a” is 0, 1, 2 or 3. “b” is 0, 1 or 2. “m” is an integer of 0 to 19. In addition, a+mb≥1 is satisfied.

In general, an alkoxy group having fewer carbon atoms is more reactive. In other words, the reactivity becomes lower in the order of the methoxy group, the ethoxy group, and the propoxy group. Therefore, an alkoxy group can be appropriately selected depending on a production method and an application of the (meth)acrylic-based copolymer (A′).

A specific structure of the (meth)acrylic ester monomer having an alkoxysilyl group is not particularly limited. An example thereof is a monomer represented by the following general formula (2):

H₂C═CR³C(═O)O—(CH₂)ₘ—SiR⁴ₙ(OR⁵)₃₋ₙ (2)

In the formula, “R³” is hydrogen or a methyl group. “R⁴” and “R⁵” can be one or more selected from the group consisting of hydrogen, a methyl group, and an ethyl group. In a case where a plurality of R⁴ and/or R⁵ groups are present, the plurality of R⁴ and/or R⁵ groups are selected independently. “m” is an integer of 0 to 10. “n” is an integer of 0 to 2.

Specific examples of the (meth)acrylic ester monomer having an alkoxysilyl group include 3-methacryloxypropyltrimethoxysilane, 3-methacryloxypropylmethyldiethoxysilane, 3-methacryloxypropyltriethoxysilane, 3-acryloxypropyltrimethoxysilane, 3-acryloxypropylmethyldimethoxysilane, and 3-methacryloxypropylmethyldimethoxysilane.

The number of alkoxysilyl groups introduced into the (meth)acrylic-based copolymer (A′) differs between the X block and the Y block, and is specifically as described above. In a case where the (meth)acrylic-based copolymer (A′) takes the XY diblock structure, on average, 1 or more, preferably 1.1 or more, and more preferably 1.2 or more alkoxysilyl groups are introduced in a whole molecule. In a case where the (meth)acrylic-based copolymer (A′) takes the XYX triblock structure or XYXY tetrablock structure, on average, 2 or more, preferably 2.2 or more, more preferably 2.4 or more alkoxysilyl groups are introduced in a whole molecule. An upper limit of the number of alkoxysilyl groups introduced into the (meth)acrylic-based copolymer (A′) may be 10.0 or less, 8.0 or less, 6.0 or less, or 4.0 or less. In a case where the number of alkoxysilyl groups is within the above range, physical properties of a curable composition and a cured product using the (meth)acrylic-based copolymer (A′) become good.

[1.3. Other Physical Properties]

The number-average molecular weight of the (meth)acrylic-based copolymer (A′) is not particularly limited, and may be 4,000 to 80,000, or 20,000 to 50,000. In a case where the number-average molecular weight is 4,000 or more, properties of the (meth)acrylic-based copolymer (A′) can be sufficiently exhibited. In a case where the number-average molecular weight is 80,000 or less, viscosity does not become excessively high, and sufficient workability can be secured. The number-average molecular weight can be measured by, for example, gel permeation chromatography (GPC).

The (meth)acrylic-based copolymer (A′) can be produced, for example, by a production method utilizing a living radical polymerization method disclosed in Patent Literature 1. Examples of the living radical polymerization method include the following methods.
Atom transfer radical polymerization (see Atom Transfer Radical Polymerization; ATRP (J. Am. Chem. Soc. 1995, 117, 5614; Macromolecules. 1995, 28, 1721))
Single electron transfer polymerization (see Single Electron Transfer Polymerization; SET-LRP (J. Am. Chem. Soc. 2006, 128, 14156; JPSChem 2007, 45, 1607))
Reversible transfer catalytic polymerization (see Reversible Chain Transfer Catalyzed Polymerization; RTCP (“Living Radical Polymerizations with Organic catalysts”, “KOBUNSHI RONBUNSHU (Japanese Journal of Polymer Science and Technology)” 68, 223-231 (2011); Japanese Patent Application Publication, Tokukai, No. 2014-111798))
Reversible addition/fragmentation chain transfer polymerization method (RAFT polymerization)
Nitroxy radical method (NMP method)
Polymerization method using an organotellurium compound (TERP)
Polymerization method using an organoantimony compound (SBRP)
Polymerization method using an organobismuth compound (BIRP)
Iodine transfer polymerization method

In a case where the production method disclosed in Patent Literature 1 is employed, halogen atoms can remain at one end or both ends (extended end(s) of a molecular chain in polymerization) of the molecule of the (meth)acrylic-based copolymer (A′). In one embodiment, the (meth)acrylic-based copolymer (A′) has, on average, one or more halogen atoms per extended end of the molecular chain in polymerization.

[2. Method for Producing (Meth)Acrylic-Based Copolymer (A′) and (Meth)Acrylic-Based Copolymer (A″)]

In one embodiment, the (meth)acrylic-based copolymer (A′) can be produced by a production method including a step 1a and a step 2a described below, or a step 1b and a step 2b described below. In the following description, “containing 0% by weight of a (meth)acrylic ester monomer having an alkoxysilyl group” means “containing no (meth)acrylic ester monomer having an alkoxysilyl group”.

(Step 1a) A step of polymerizing a (meth)acrylic ester monomer mixture with use of a living polymerization initiator, the (meth)acrylic ester monomer mixture containing more than 3% by weight of a (meth)acrylic ester monomer having an alkoxysilyl group.

(Step 2a) A step of adding, to a reaction system after the step 1a, a (meth)acrylic ester monomer mixture containing 0% by weight to 3% by weight of a (meth)acrylic ester monomer having an alkoxysilyl group, and polymerizing the reaction system.

(Step 1b) A step of polymerizing a (meth)acrylic ester monomer mixture with use of a living polymerization initiator, the (meth)acrylic ester monomer mixture containing 0% by weight to 3% by weight of a (meth)acrylic ester monomer having an alkoxysilyl group.

(Step 2b) A step of adding, to a reaction system after the step 1b, a (meth)acrylic ester monomer mixture containing more than 3% by weight of a (meth)acrylic ester monomer having an alkoxysilyl group, and polymerizing the reaction system.

In one embodiment, the living polymerization initiator is a living radical polymerization initiator. As the living radical polymerization initiator, a known substance is used.

Hereinafter, each of the steps will be described more specifically for each structure of the (meth)acrylic-based copolymer (A′).

(Case where Copolymer has XY Diblock Structure)

A (meth)acrylic-based copolymer (A′) which is a molecule having the XY diblock structure can be produced by the step 1a and the step 2a, or by the step 1b and the step 2b. In this case, an X block containing a relatively large amount of alkoxysilyl groups is formed by the step 1a and the step 2b. Meanwhile, a Y block containing a relatively small amount of alkoxysilyl groups is formed by the step 2a and the step 1b.

In the step 1a, the (meth)acrylic ester monomer having the alkoxysilyl group is polymerized with use of the living polymerization initiator. As the living polymerization initiator, for example, an initiator having one halogen group in its molecule can be used. An amount of the (meth)acrylic ester monomer having the alkoxysilyl group can be 1 to 10 molar equivalents, with respect to 1 molar equivalent of the initiator. According to need, 1 to 100 molar equivalents of a (meth)acrylic ester monomer having no alkoxysilyl group can be polymerized together. An amount of the (meth)acrylic ester monomer having the alkoxysilyl group added to the reaction system in the step 1a accounts for more than 3% by weight of the monomer mixture added to the reaction system in the step 1a.

In the step 2a, a (meth)acrylic ester monomer having no alkoxysilyl group is added to and polymerized with the reaction system after the step 1a. An added amount of the (meth)acrylic ester monomer having no alkoxysilyl group can be 2 to 600 molar equivalents, with respect to 1 molar equivalent of a polymer obtained in the step 1a. In the step 2a, a (meth)acrylic ester monomer having an alkoxysilyl group can be added to the reaction system. An amount of the (meth)acrylic ester monomer having the alkoxysilyl group added to the reaction system in the step 2a accounts for 0% by weight to 3% by weight of the monomer mixture added to the reaction system in the step 2a.

In the step 1b, a (meth)acrylic ester monomer having no alkoxysilyl group is polymerized with use of the living polymerization initiator. The living polymerization initiator can be identical with that used in the step 1a. An amount of the (meth)acrylic ester monomer having no alkoxysilyl group can be 2 to 600 molar equivalents, with respect to 1 molar equivalent of the initiator. In the step 1b, a (meth)acrylic ester monomer having an alkoxysilyl group can be added to the reaction system. An amount of the (meth)acrylic ester monomer having an alkoxysilyl group added to the reaction system in the step 1b accounts for 0% by weight to 3% by weight of the monomer mixture added to the reaction system in the step 1b.

In the step 2b, a (meth)acrylic ester monomer having an alkoxysilyl group is added to and polymerized with the reaction system after the step 1b. An amount of the (meth)acrylic ester monomer having an alkoxysilyl group can be 1 to 10 molar equivalents, with respect to 1 molar equivalent of the polymer obtained in the step 1b. According to need, 1 to 100 molar equivalents of a (meth)acrylic ester monomer having no alkoxysilyl group can be polymerized together. An amount of the (meth)acrylic ester monomer having the alkoxysilyl group added to the reaction system in the step 2b accounts for more than 3% by weight of the monomer mixture added to the reaction system in the step 2b.

In the above steps, examples of the “(meth)acrylic ester monomer having no alkoxysilyl group” include the (meth)acrylic ester monomers (α), (β), (γ), and (δ) described in Section [1]. This also applies to the following descriptions.

(Case where Copolymer has XYX Triblock Structure)

A (meth)acrylic-based copolymer (A′) which is a molecule having the XYX triblock structure can be produced by the above described step 1a and step 2a, followed by an additional polymerization step (a). In this case, an X block containing a relatively large amount of alkoxysilyl groups is formed by the step 1a and the additional polymerization step (a).

In the additional polymerization step (a), a (meth)acrylic ester monomer having an alkoxysilyl group is added to and polymerized with the reaction system after the step 2a. An added amount of the (meth)acrylic ester monomer having an alkoxysilyl group can be 1 to 10 molar equivalents, with respect to 1 molar equivalent of a polymer obtained in the step 2a. According to need, 1 to 100 molar equivalents of a (meth)acrylic ester monomer having no alkoxysilyl group can be polymerized together. An amount of the (meth)acrylic ester monomer having an alkoxysilyl group added to the reaction system in the additional polymerization step (a) accounts for more than 3% by weight of the monomer mixture added to the reaction system in that step.

A (meth)acrylic-based copolymer (A′) which is a molecule having a Y×Y triblock structure can be produced by the above described step 1b and step 2b, followed by an additional polymerization step (b). In this case, an X block containing a relatively large amount of alkoxysilyl groups is formed by the step 2b.

In the additional polymerization step (b), a (meth)acrylic ester monomer having no alkoxysilyl group is added to and polymerized with the reaction system after the step 2b. An added amount of the (meth)acrylic ester monomer having no alkoxysilyl group can be 2 to 600 molar equivalents, with respect to 1 molar equivalent of a polymer obtained in the step 2b. In the additional polymerization step (b), a (meth)acrylic ester monomer having an alkoxysilyl group can be added to the reaction system. An amount of the (meth)acrylic ester monomer having the alkoxysilyl group added to the reaction system in the additional polymerization step (b) accounts for 0% by weight to 3% by weight of the monomer mixture added to the reaction system in that step.

(Case where Copolymer has Four or More Blocks)

By appropriately combining the step 1a, the step 2a, the additional polymerization step (a), the step 1b, the step 2b, and the additional polymerization step (b) described above, a (meth)acrylic-based copolymer (A′) having four or more blocks can be produced. For example, it is possible to produce a (meth)acrylic-based copolymer (A′) having an XYXY tetrablock structure.

(Method for Producing (Meth)Acrylic-Based Copolymer (A″))

In the production method described above, a (meth)acrylic-based copolymer (A″) can be produced by appropriately adjusting an amount of the (meth)acrylic ester monomer (α) added as the (meth)acrylic ester monomer having no alkoxysilyl group. Specifically, a (meth)acrylic-based copolymer (A″) can be produced in a case where the (meth)acrylic ester monomer having no alkoxysilyl group, which is added to the reaction system in the above steps, contains 5% by weight to 20% by weight of the (meth)acrylic ester monomer (α), with respect to a weight of all monomers.

The above production method can be suitably carried out by employing a living radical polymerization method. Among the living radical polymerization methods described above, the atom transfer radical polymerization, the single electron transfer polymerization, and the reversible transfer catalytic polymerization are preferable.

As a more preferable production method, a living radical polymerization method using a vinyl-based monomer can be employed in which a transition metal or a transition metal complex (constituted by a transition metal compound and a ligand) is used as a catalyst in ATRP or SET-LRP. In addition, RTCP that does not use transition metals as a catalyst can also be employed.

A mechanism of living radical polymerization using a transition metal complex as a catalyst currently has two interpretations, i.e., ATRP and SET-LRP. Interpreting on the basis of ATRP, living radical polymerization includes equilibrium of the following two reactions (as an example, a case using a copper complex will be described).

(a) A monovalent copper complex becomes a bivalent copper complex by removing halogen from a polymer terminus to generate a radical.

(b) A bivalent copper complex becomes a monovalent copper complex by addition of halogen to a radical at a polymer terminus.

Meanwhile, interpreting on the basis of SET-LRP, living radical polymerization includes equilibrium of the following three reactions (as an example, a case using a copper complex will be described).

(a) A zerovalent metallic copper or copper complex becomes a bivalent copper complex by removing halogen from a polymer terminus to generate a radical.

(b) A bivalent copper complex becomes a zerovalent copper complex by addition of halogen to a radical at a polymer terminus.

(c) A monovalent copper complex becomes zerovalent and bivalent copper complexes by disproportionation.

The production method described above can also be interpreted as any of the living radical polymerization systems. Note, however, that those living radical polymerization systems are not particularly distinguished in one or more embodiments of the present invention. All living radical polymerization systems using, as a catalyst, a transition metal or a transition metal compound and a ligand are encompassed in the scope of one or more embodiments of the present invention.

Activators regenerated by electron transfer (ARGET), which are a synthetic method with improved ATRP, have also been reported (Macromolecules. 2006, 39, 39). In this method, by reducing a highly-oxidized transition metal complex, which causes delay or termination of polymerization, using the reducing agent, a polymerization reaction can rapidly proceed to a high reaction rate even under a low catalyst condition in which an amount of the transition metal complex is small. This ARGET can also be employed in one or more embodiments of the present invention.

(Identification of Structure of (Meth)Acrylic-Based Copolymer (A′) Based on Production Method)

In one embodiment, the (meth)acrylic-based copolymer (A′) is defined as a copolymer obtained by the above described production method. That is, the (meth)acrylic-based copolymer (A′) can be a copolymer obtained by a production method including the step 1a and the step 2a, or the step 1b and the step 2b.

In the production method described above, a (meth)acrylic ester monomer having an alkoxysilyl group is introduced by copolymerization. Therefore, it is almost impractical to specifically identify a position of the alkoxysilyl group in a resultant copolymer molecule.

In addition, in a case where the (meth)acrylic ester monomer having no alkoxysilyl group of the same type is added to the reaction systems in the step 1a and the step 2a (or the step 1b and the step 2b) in the above described production method, a main chain structure of the obtained copolymer becomes the same in both the X block and the Y block. In such a copolymer, it is almost impractical to specifically identify a boundary between the X block and the Y block.

Due to such circumstances, the (meth)acrylic-based copolymer (A′) may need to be defined as a copolymer obtained by the above described production method, rather than being defined as a specific structure of a copolymer molecule.

The following description will individually discuss various agents which can be used in the production method in accordance with one or more embodiments of the present invention. All of those agents can be used alone, or two or more types thereof can be used in combination. Moreover, those agents themselves can be introduced into the polymerization system, or those agents can be generated in the polymerization system.

[2.1. Initiator]

As an initiator, it is possible to use a radical initiator having one halogen group in its molecule. Examples of the initiator include ethyl 2-bromoisobutyrate, ethyl 2-bromobutyrate (also called α-ethyl bromobutyrate), ethyl bromoacetate, methyl bromoacetate, (1-bromoethyl)benzene, allyl bromide, methyl 2-bromopropionate, methyl chloroacetate, methyl 2-chloropropionate, and (1-chloroethyl)benzene.

From the viewpoint of easy availability, ethyl 2-bromobutyrate, (1-bromoethyl)benzene, and methyl chloroacetate are preferable. From the viewpoint of reactivity and safety, ethyl 2-bromobutyrate is preferable.

As an initiator, it is possible to use an initiator having an alkoxysilyl group. Alternatively, an alkoxysilyl group can be introduced into the initiator, at a point in time such as prior to a polymerization reaction or after a polymerization reaction. By such a method also, a (meth)acrylic-based copolymer (A′) having an alkoxysilyl group at least at an end part can be produced.

[2.2. Polymerization Catalyst]

In both cases where the reducing agent is used and the reducing agent is not used, in an ATRP system, it is possible to use a metal complex having, as a central metal, an element of Group 7, Group 8, Group 9, Group 10, or Group 11 of the periodic table. Among those, particularly, a metal complex containing monovalent copper, bivalent ruthenium, or bivalent iron as a central metal is suitable.

Specific examples include cuprous chloride, cuprous bromide, cuprous iodide, cuprous cyanide, cuprous oxide, cuprous acetate, cuprous perchlorate, and the like. In a case where a copper compound is used as a polymerization catalyst, an amine ligand may be added to the polymerization system in order to enhance catalytic activity. Moreover, a tristriphenylphosphine complex of bivalent ruthenium chloride (RuCl₂(PPh₃)) is also suitable as a catalyst. In a case where this catalyst is used, it is preferable to add an aluminum compound (such as trialkoxyaluminum) to the polymerization system in order to enhance catalytic activity. Further, a tristriphenylphosphine complex of bivalent iron chloride (FeCl₂(PPh₃)₃) is also suitable as a catalyst.

Among those described above, the copper catalyst is preferable because the copper catalyst is inexpensive. In order to enhance the catalytic activity and enhance productivity, it is more preferable to use polydentate amine and the copper catalyst in combination.

[2.3. Polydentate Amine]

Examples of polydentate amine that can be used as a ligand include:
Bidentate amines: 2,2-bipyridine, 4,4′-di-(5-nonyl)-2,2′-bipyridine, N-(n-propyl)pyridylmethaneimine, and N-(n-octyl)pyridylmethaneimine
Tridentate amines: N,N,N′,N″,N″ pentamethyldiethylenetriamine, and N-propyl-N,N-di(2-pyridylmethyl)amine
Tetradentate amines: hexamethyltris(2-aminoethyl)amine (Me₆TREN), N,N-bis(2-dimethylaminoethyl)-N,N′-dimethylethylenediamine, 2,5,9,12-tetramethyl-2,5,9,12-tetraazatetradecane, 2,6,9,13-tetramethyl-2,6,9,13-tetraazatetradecane, 4,11-dimethyl-1,4,8,11-tetraazabicyclohexadecane, N′,N″-dimethyl-N′,N″-bis((pyridin-2-yl)methyl)ethane-1,2-diamine, tris[(2-pyridyl)methyl]amine, and 2,5,8,12-tetramethyl-2,5,8,12-tetraazatetradecane
Pentadentate amines: N,N,N′,N″,N′″,N″″,N″″-heptamethyl tetraethylenetetramine
Hexadentate amines: N,N,N′,N′-tetrakis(2-pyridylmethyl) ethylenediamine
Polyamine: polyethyleneimine

[2.4. Base]

A base can be added to the polymerization system in order to neutralize acid present or generated in the polymerization system to prevent accumulation of the acid. Examples of the base include:
Monoamine: “Monoamine” refers to a compound in which one site acts as a base per molecule. Examples of monoamine include: primary amines (such as methylamine, aniline, and lysine), secondary amines (such as dimethylamine and piperidine), tertiary amines (such as trimethylamine and triethylamine), aromatic amines (such as pyridine and pyrrole), and ammonia.
Polyamine: Examples of polyamine include diamine (such as ethylenediamine and tetramethylethylenediamine), triamine (such as diethylenetriamine and pentamethyldiethylenetriamine), tetramine (such as triethylenetetramine, hexamethyltriethylenetetramine, and hexamethylenetetramine), polyethyleneimine, and the like.
Inorganic base: An “inorganic base” refers to a single substance or a compound of elements belonging to Groups 1 and 2 of the periodic table. Examples of the single substance of elements belonging to Groups 1 and 2 of the periodic table include lithium, sodium, and calcium. Examples of the compound of elements belonging to Groups 1 and 2 of the periodic table include sodium methoxide, potassium ethoxide, methyllithium, sodium hydroxide, potassium hydroxide, potassium carbonate, sodium hydrogencarbonate, ammonium hydrogencarbonate, trisodium phosphate, disodium hydrogen phosphate, tripotassium phosphate, dipotassium hydrogen phosphate, sodium acetate, potassium acetate, sodium oxalate, potassium oxalate, phenoxysodium, phenoxypotassium, sodium ascorbate, and potassium ascorbate.

[2.5. Reducing Agent]

In living radical polymerization using a copper complex as a catalyst, it is known that polymerization activity is improved by using a reducing agent in combination (ARGET ATRP). In ARGET ATRP, it is considered that the polymerization activity is improved by reduction to reduce a highly-oxidized transition metal complex (generated by coupling of radicals) which causes delay or termination of a polymerization reaction. This makes it possible to reduce a transition metal catalyst, which is usually needed in an amount of hundreds to thousands of ppm, to an amount of tens to hundreds of ppm. In the production method in accordance with one or more embodiments of the present invention, it is possible to achieve a reaction mechanism similar to that of ARGET ATRP by using the reducing agent. Examples of the reducing agent include the following materials.

(Reducing Agent that Generates No Acid when Reducing Copper Complex)
Metal: Examples of the metal include alkali metals (such as lithium, sodium, and potassium), alkaline-earth metals (such as beryllium, magnesium, calcium, and barium), main group metals (such as aluminum and zinc), and transition metals (such as copper, nickel, ruthenium, and iron). These metals can also be used in the form of an alloy with mercury (amalgam).
Metal compound: Examples of the metal compound include a metal salt and a metal complex. Examples of a ligand coordinated in the metal complex include a carbon monoxide, an olefin, a nitrogen-containing compound, an oxygen-containing compound, a phosphate-containing compound, and a sulfur-containing compound. More specific examples include compounds of metals with ammonia/amine, titanium trichloride, titanium alkoxide, chromium chloride, chromium sulfate, chromium acetate, iron chloride, copper chloride, copper bromide, tin chloride, zinc acetate, zinc hydroxide, carbonyl complexes (such as Ni(CO)₄ and Co₂CO₈), olefin complexes (such as [Ni(cod)₂], [RuCl₂(cod)], and [PtCl₂(cod)]; “cod” stands for cyclooctadiene), phosphine complexes (such as [RhCl(P(C₆H₅)₃)₃], [RuCl₂(P(C₆H₅)₃)₂], and [PtCl₂(P(C₆H₅)₃)₂]).
Organotin compounds: Specific examples thereof include tin octylate, tin 2-ethylhexylate, dibutyltin diacetate, dibutyltin dilaurate, dibutyltin mercaptide, dibutyltin thiocarboxylate, dibutyltin dimaleate, and dioctyltin thiocarboxylate.
Phosphorus or phosphorus compound: Specific examples thereof include phosphorus, trimethylphosphine, triethylphosphine, triphenylphosphine, trimethylphosphite, triethylphosphite, triphenylphosphite, hexamethylphosphorous triamide, and hexaethylphosphorous triamide.
Sulfur or sulfur compounds: Specific examples thereof include sulfur, Rongalites, hydrosulfites, and thiourea dioxide. Rongalite refers to a formaldehyde derivative of sulfoxylate, and is represented by a general formula: MSO₂.CH₂O (where “M” is Na or Zn). Specific examples of the Rongalite include sodium formaldehyde sulfoxylate and zinc formaldehyde sulfoxylate. Hydrosulfite refers to formaldehyde derivatives of sodium hyposulfite and sodium hyposulfite.

(Reducing Agent (Hydride Reducing Agent) that Generates Acid when Reducing Copper Complex)
Metal hydride: Specific examples thereof include sodium hydride, germanium hydride, tungsten hydride, aluminum hydrides (such as diisobutylaluminum hydride, lithium aluminum hydride, sodium aluminum hydride, sodium triethoxyaluminum hydride, and sodium bis(2-methoxyethoxy)aluminum hydride), and organotin hydrides (such as triphenyltin hydride, tri-n-butyltin hydride, diphenyltin hydride, di-n-butyltin hydride, triethyltin hydride, and trimethyltin hydride).
Silicon hydride: Specific examples thereof include trichlorosilane, trimethylsilane, triethylsilane, diphenylsilane, phenylsilane, and polymethylhydrosiloxane.
Boron hydride: Specific examples thereof include borane, diborane, sodium borohydride, sodium trimethoxyborate hydride, sodium sulfide borohydride, sodium cyanide borohydride, lithium cyanide borohydride, lithium borohydride, lithium triethylborohydride, lithium tri-s-butylborohydride, lithium tri-t-butylborohydride, calcium borohydride, potassium borohydride, zinc borohydride, tetra-n-butylammonium borohydride.
Nitrogen hydride: Specific examples thereof include hydrazine and diimide.
Phosphorus or phosphorus compound: Specific examples thereof include phosphine and diazaphospholene.
Sulfur or sulfur compounds: Specific examples thereof include hydrogen sulfide.
Organic compound exhibiting reducing action: Specific examples thereof include alcohol, aldehyde, phenols, and organic acid compounds. Examples of the alcohol include methanol, ethanol, propanol, and isopropanol. Examples of the aldehyde include formaldehyde, acetaldehyde, benzaldehyde, and formic acid. Examples of the phenols include phenol, hydroquinone, dibutylhydroxytoluene, and tocopherol. Examples of the organic acid compounds include citric acid, oxalic acid, ascorbic acid, ascorbate, and ascorbic acid ester.

The reducing agent can be generated in the polymerization system by electrolytic reduction. In electrolytic reduction, electrons generated at the cathode exhibit a reduction action directly (or after solvation). In other words, the reducing agent can be generated by electrolysis.

[2.6. Solvent]

Examples of the solvent include the following materials. Note, however, that ATRP can be carried out also under a condition using no solvent.
Highly polar aprotic solvent: dimethyl sulfoxide (DMSO), dimethylformamide (DMF), N,N-dimethylacetamide (DMAc), and N-methylpyrrolidone
Carbonate-based solvent: ethylene carbonate and propylene carbonate
Alcohol-based solvent: methanol, ethanol, propanol, isopropanol, n-butyl alcohol, and tert-butyl alcohol
Nitrile-based solvent: acetonitrile, propionitrile, and benzonitrile
Ketone-based solvent: acetone, methyl ethyl ketone, and methyl isobutyl ketone
Ether-based solvent: diethyl ether and tetrahydrofuran
Halocarbon-based solvent: methylene chloride and chloroform
Ester-based solvent: ethyl acetate and butyl acetate
Hydrocarbon-based solvent: pentane, hexane, heptane, cyclohexane, octane, decane, benzene, toluene, and xylene
Other solvents: ionic liquids, water, and supercritical fluids.

In the ATRP (ARGET) system using the reducing agent, it is preferable that the transition metal or transition metal compound, the polydentate amine, the base, the reducing agent, the monomer, and the initiator are uniform in the polymerization system, from the viewpoint of reaction control, polymerization reaction rate, easiness in introduction, and scale-up risk. Therefore, it is preferable to select a solvent in which these substances can be dissolved.

[3. Composition Containing (Meth)Acrylic-Based Copolymer (A′) and/or (Meth)Acrylic-Based Copolymer (A′) and Epoxy Compound (C)]

An aspect of one or more embodiments of the present invention is a composition containing a (meth)acrylic-based copolymer (A′) and an epoxy compound (C). In one embodiment, the composition contains a (meth)acrylic-based copolymer (A″) and an epoxy compound (C). According to the composition, it is possible to reduce storage viscosity (particularly, storage viscosity in a high temperature environment) of the (meth)acrylic-based copolymer (A′) and/or the (meth)acrylic-based copolymer (A″).

The (meth)acrylic-based copolymer (A′) and/or the (meth)acrylic-based copolymer (A″) is highly viscous. Therefore, when being transferred from a polymerization pot to a storage tank, a tank truck, or the like after production, the copolymer may be heated to reduce viscosity and transferred with thus reduced viscosity. Moreover, when the (meth)acrylic-based copolymer (A′) and/or the (meth)acrylic-based copolymer (A″) is exported to Australia, Brazil, and the like in the southern hemisphere, a preservation environment of the copolymer can be 50° C. or higher because the ship passes directly below the equator. Therefore, it is preferable that the viscosity of the copolymer does not increase in a high temperature environment. According to an aspect of one or more embodiments of the present invention, the (meth)acrylic-based copolymer (A′) and/or the (meth)acrylic-based copolymer (A″) is combined with the epoxy compound (C), and thus the viscosity of the copolymer immediately after production and/or during storage can be reduced.

In this specification, a test is conducted in which the (meth)acrylic-based copolymer (A′) and/or the (meth)acrylic-based copolymer (A″) is heated to and kept at 80° C. for 4 weeks, for testing enhancement of storage stability in a high temperature environment. As a result of this test, a copolymer having a lower viscosity increase ratio is preferable. The viscosity increase ratio is calculated by a formula: {(viscosity after test−viscosity before test)/viscosity before test}×100. The viscosity increase ratio of the composition after the test may be 65% or less, 50% or less, or 30% or less.

Here, the “high temperature environment” refers to an environment at 50° C. or more (preferably 80° C. or more). In addition, the phrase “reducing storage viscosity” means that the viscosity after the composition is stored for 1 week or more (preferably 4 weeks or more) is lower than the viscosity after only the (meth)acrylic-based copolymer (A′) and/or the (meth)acrylic-based copolymer (A″) is stored for the same period of time. Note that “reducing storage viscosity in a high temperature environment” includes “reducing storage viscosity in an intermittent high temperature environment”. For example, “reducing storage viscosity in a high temperature environment” also includes a case where the viscosity after the composition is stored in an environment at 50° C. or more (preferably 80° C. or more) for a total of 1 week or more (preferably 4 weeks or more) is lower than the viscosity after only the (meth)acrylic-based copolymer (A′) and/or the (meth)acrylic-based copolymer (A″) is stored for the same period of time.

The (meth)acrylic-based copolymer (A′) and the (meth)acrylic-based copolymer (A″) contained in the composition in accordance with one or more embodiments of the present invention are as described in Sections [1] and [2].

In one or more embodiments, the composition can be produced by mixing the (meth)acrylic-based copolymer (A′) produced by the method described in Section [2] and the epoxy compound (C). That is, in a case where the (meth)acrylic-based copolymer (A′) has the XY diblock structure, the composition can be produced by a step 3a or a step 3b described below. In a case where the (meth)acrylic-based copolymer (A′) has the XYX triblock structure, the composition can be produced by the step 3a below. Even in a case where the (meth)acrylic-based copolymer (A′) has four or more blocks, the composition can be obtained by mixing with the epoxy compound (C) in a similar manner.
Step 3a: A step of mixing the (meth)acrylic-based copolymer (A′) obtained through the step 1a, the step 2a, and optionally the additional polymerization step (a) with the epoxy compound (C).
Step 3b: A step of mixing the (meth)acrylic-based copolymer (A′) obtained through the step 1b, the step 2b, and optionally the additional polymerization step (b) with the epoxy compound (C).

In the composition in accordance with one or more embodiments of the present invention, a mechanism for lowering the storage viscosity of the (meth)acrylic-based copolymer (A′) and/or the (meth)acrylic-based copolymer (A″) is inferred as follows (note that this mechanism is intended to help understand one or more embodiments of the present invention, and is not intended to limit one or more embodiments of the present invention).

1. The (meth)acrylic-based copolymer (A′) and/or the (meth)acrylic-based copolymer (A″) produced by the production method disclosed in Patent Literature 1 has a halogen atom remaining at an extended end of a molecular chain. When this halogen atom is eliminated, hydrogen halide is generated.
2. Since the hydrogen halide is an acid, the hydrogen halide promotes hydrolysis of an alkoxysilyl group contained in the (meth)acrylic-based copolymer (A′) and/or the (meth)acrylic-based copolymer (A″). In addition, a siloxane bond occurs between the hydrolyzed alkoxysilyl groups. That is, crosslinking between molecules of the (meth)acrylic-based copolymer (A′) and/or the (meth)acrylic-based copolymer (A″) proceeds, and viscosity increases (ultimately, becomes a gel-like material).
3. However, by adding the epoxy compound (C), the hydrogen halide can be captured. Therefore, the progress of the reaction described in 2. is inhibited, and the viscosity can be kept low.

Therefore, it is preferable that the composition in accordance with one or more embodiments of the present invention contains a sufficient amount of the epoxy compound (C) to capture hydrogen halide that can be generated. This amount may be 1 molar equivalent or more, or 2 molar equivalents or more, with respect to halogen atoms contained in the (meth)acrylic-based copolymer (A′) and/or the (meth)acrylic-based copolymer (A″).

In a case where the epoxy compound (C) is added to the (meth)acrylic-based copolymer (A′) and/or the (meth)acrylic-based copolymer (A″), it is possible to inhibit an increase in viscosity of the copolymer at a high temperature and to improve storage stability. A concentration of the (meth)acrylic-based copolymer (A′) and/or the (meth)acrylic-based copolymer (A″) in the composition may be 50% by weight to 99.9% by weight, or 70% by weight to 99.5% by weight. A concentration of the epoxy compound (C) in the composition may be 0.01% by weight to 50% by weight, or 0.5% by weight to 30% by weight. Assuming that an amount of the (meth)acrylic-based copolymer (A′) and/or the (meth)acrylic-based copolymer (A″) is 100 parts by weight, an upper limit of a contained amount of the epoxy compound (C) can be not more than 100 parts by weight, not more than 50 parts by weight, not more than 20 parts by weight, not more than 10 parts by weight, not more than 5 parts by weight, not more than 3 parts by weight, not more than 2 parts by weight, and not more than 1 part by weight. Assuming that an amount of the (meth)acrylic-based copolymer (A′) and/or the (meth)acrylic-based copolymer (A″) is 100 parts by weight, a lower limit of a contained amount of the epoxy compound (C) can be not less than 0.001 parts by weight, not less than 0.005 parts by weight, not less than 0.01 parts by weight, not less than 0.05 parts by weight, not less than 0.1 parts by weight, not less than 0.2 parts by weight, not less than 0.3 parts by weight, not less than 0.4 parts by weight, or not less than 0.5 parts by weight.

In a case where the amount of the epoxy compound (C) added is large, the viscosity of the composition tends to decrease. However, in a case where the amount of the epoxy compound (C) added is large, mechanical strength of a cured product obtained from the composition can decrease. Therefore, it is preferable to appropriately adjust the amount of the epoxy compound (C) added in accordance with intended mechanical strength of a cured product.

[3.1. Epoxy Compound (C)]

The epoxy compound (C) is not particularly limited, and a conventionally known compound can be used. Examples of the epoxy compound (C) include materials below. Those epoxy compounds can be used alone, or two or more types thereof can be used in combination. In one embodiment, the epoxy compound (C) is one or more selected from the group consisting of epoxidized unsaturated fats and oils, an epoxy plasticizer, and monoepoxide.

(Monoepoxide)

Monoepoxide refers to a compound having one epoxy group in its molecule. Specific examples of monoepoxide include:
Hydrocarbon-based oxides having 2 to 24 carbon atoms: ethylene oxide, propylene oxide, 1-butene oxide, 2-butene oxide, α-olefin oxide having 5 to 24 carbon atoms, and styrene oxide
Substituted or unsubstituted glycidyl ethers of hydrocarbon having 2 to 19 carbon atoms: 2-phenoxyisopropyl glycidyl ether, n-butyl glycidyl ether, allyl glycidyl ether, 2-ethyl-hexyl glycidyl ether, 2-methyloctyl glycidyl ether, phenyl glycidyl ether, cresyl glycidyl ether, p-sec-butylphenyl glycidyl ether, and p-tert-butylphenyl glycidyl ether
Glycidyl esters of monocarboxylic acid having 3 to 30 carbon atoms: glycidyl acrylate and glycidyl methacrylate
Epihalohydrin: epichlorohydrin and epibromohydrin
Hydroxyl-containing oxide: glycidol
Epoxysilane compound: 3-glycidoxypropyltrimethoxysilane, 3-glycidoxypropylmethyldimethoxysilane, 3-glycidoxypropyltriethoxysilane, 4-oxiranylbutyltrimethoxysilane, 8-oxiranyloctyltrimethoxysilane, and 2-(3,4-epoxycyclohexyl)ethyltrimethoxysilane
Monofunctional cycloaliphatic epoxy compound: 4-vinylepoxycyclohexane, dioctyl epoxyhexahydrophthalate, di-2-ethyihexyl epoxyhexahydrophthalate, and vinylcyclohexene monoepoxide.

(Polyepoxide)

Polyepoxide refers to a compound having two or more epoxy groups in its molecule. Examples of polyepoxide include:

Glycidyl Ether Type:

(a) Diglycidyl ethers of dihydric phenols: For example, diglycidyl ethers of dihydric phenols having 6 to 30 carbon atoms. Specific examples thereof include bisphenol F diglycidyl ether, bisphenol A diglycidyl ether, bisphenol B diglycidyl ether, bisphenol AD diglycidyl ether, bisphenol S diglycidyl ether, halogenated bisphenol A diglycidyl ether, tetrachlorobisphenol A diglycidyl ether, catechin diglycidyl ether, resorcinol diglycidyl ether, hydroquinone diglycidyl ether, 1,5-dihydroxynaphthalene diglycidyl ether, dihydroxybiphenyl diglycidyl ether, octachloro-4,4′-dihydroxybiphenyldiglycidyl ether, tetramethyl biphenyl diglycidyl ether, 9,9-bis(4-hydroxyphenyl)fluorene diglycidyl ether, and the like. Other examples include diglycidyl ether which is a reactant of 2 moles of bisphenol A and 3 moles of epichlorohydrin.

(b) Polyglycidyl ethers of trihydric to hexahydric or more polyhydric phenols: polyglycidyl ethers of trihydric to hexahydric or more polyhydric phenols having 6 to 50 or more carbon atoms and having a molecular weight of 250 to 5000.

(c) Diglycidyl ethers of aliphatic dihydric alcohols: for example, diglycidyl ethers of diol having 2 to 100 carbon atoms and having a molecular weight of 150 to 5000. Specifically, 1,3-bis[3-(glycidyloxy)propyl]-1,1,3,3-tetramethylpropanedisiloxane, or the like.

(d) Polyglycidyl ethers of trihydric to hexahydric or more aliphatic alcohols: for example, glycidyl ethers of trihydric to hexahydric or more polyhydric alcohols having 3 to 50 or more carbon atoms and having a molecular weight of 92 to 10000.
Glycidyl ester type: for example, glycidyl esters of bivalent to hexavalent or more aromatic polycarboxylic acid having 6 to 20 or more carbon atoms. Other examples include glycidyl esters of bivalent to hexavalent or more aliphatic or alicyclic polycarboxylic acid having 6 to 20 or more carbon atoms.
Glycidylamine type: for example, glycidylamines of aromatic amines having 6 to 20 or more carbon atoms and having 2 to 10 or more active hydrogen atoms. Other examples include glycidylamines of aliphatic, alicyclic, or heterocyclic amines.
Chain aliphatic epoxide: for example, bivalent to hexavalent or more chain aliphatic epoxides having 6 to 50 or more carbon atoms.
Alicyclic epoxide: for example, alicyclic epoxides having 6 to 50 or more carbon atoms, having a molecular weight of 90 to 2500, and having 2 to 4 or more epoxy groups. Specific examples thereof include vinylcyclohexene dioxide, limonene dioxide, dicyclopentadiene dioxide, bis(2,3-epoxy cyclopentyl)ether, ethylene glycol bisepoxy dicyclopentyl ether, 3,4epoxy-6-methylcyclohexylmethyl, 3′,4′-epoxy-6′-methylcyclohexanecarboxylate, bis(3,4-epoxy-6-methylcyclohexylmethyl)adipate, bis(3,4-epoxy-6-methylcyclohexylmethyl)butylamine. Hydrogenated products of the epoxy compounds of phenols described above are also included in the alicyclic epoxide.

### Further Examples of Epoxy Compound

Bisphenol type epoxy resin: bisphenol A epoxy resin, bisphenol F epoxy resin, bisphenol AD epoxy resin, hydrogenated bisphenol A epoxy resin, hydrogenated bisphenol F epoxy resin, bisphenol S epoxy resin, glycidyl ester type epoxy resin, glycidylamine type epoxy resin, novolac type epoxy resin, glycidyl ether type epoxy resin of bisphenol A propylene oxide adduct, hydrogenated bisphenol A epoxy resin, fluorinated epoxy resin, rubber-modified epoxy resin containing polybutadiene or NBR, flame-resistant epoxy resins (such as glycidyl ether of tetrabromobisphenol A), p-oxybenzoic acid glycidyl ether ester type epoxy resin, m-aminophenol type epoxy resin, diaminodiphenylmethane-based epoxy resin, urethane-modified epoxy resin having a urethane bond, alicyclic epoxy resin, N,N-diglycidylaniline, N,N-diglycidyl-o-toluidine, triglycidyl isocyanurate, polyalkylene glycol diglycidyl ether, glycidyl ether of polyhydric alcohol such as glycerin, hydantoin-type epoxy resin, epoxidized unsaturated polymer (such as petroleum resin), and the like. As used herein, the term “hydrogenated” refers to a type in which a benzene ring portion is changed into a cyclohexyl ring by addition of hydrogen.
Alicyclic epoxy resin: for example, a compound having a cyclohexene oxide group, a tricyclodecene oxide group, a cyclopentene oxide group, or the like. Specific examples thereof include vinylcyclohexene diepoxide, vinylcyclohexene monoepoxide, 3,4-epoxycyclohexylmethyl-3,4-epoxycyclohexanecarboxylate, 2-(3,4-epoxycyclohexyl 5,5-spiro-3,4-epoxy)cyclohexane-m-dioxane, bis(3,4-epoxycyclohexyl)adipate, bis(3,4-epoxycyclohexylmethylene)adipate, and the like.

The epoxy compound (C) also includes materials exemplified as follows: epoxidized unsaturated fats and oils (such as epoxidized soybean oil and epoxidized linseed oil), epoxidized unsaturated fatty acid esters (epoxyoctyl stearate, epoxybutyl stearate), alicyclic epoxy compounds (such as di-(2-ethylhexyl)4,5-epoxycyclohexane-1,2-dicarboxylate), epichlorohydrin derivatives, and mixtures thereof, and the like.

The epoxy compound (C) can be an epoxy plasticizer. Specific examples of the epoxy plasticizer include epoxidized soybean oil, epoxidized linseed oil, di-(2-ethylhexyl)4,5-epoxycyclohexane-1,2-dicarboxylate (E-PS), epoxyoctyl stearate, and epoxybutyl stearate.

The epoxy compound (C) can be a commercially available compound. Examples of such commercially available products include SANSO CIZER 2000H (epoxidized soybean oil; New Japan Chemical Co., Ltd.), SANSO CIZER 9000H (epoxidized linseed oil; New Japan Chemical Co., Ltd.), SANSO CIZER E-PS (di-(2-ethylhexyl)4,5-epoxycyclohexane-1,2-dicarboxylate; New Japan Chemical Co., Ltd.), Epolite M1230 (C12,13 mixed higher alcohol glycidyl ether; Kyoeisha Chemical Co., Ltd.)

[4. Curable Composition]

A curable composition in accordance with one or more embodiments of the present invention contains the composition described in Section [3] and a polyoxyalkylene-based polymer (B) having an alkoxysilyl group.

[4.1. Polyoxyalkylene-Based Polymer (B) Having Alkoxysilyl Group]

(Main Chain of Polyoxyalkylene-Based Polymer (B) Having Alkoxysilyl Group)

A main chain structure of the polyoxyalkylene-based polymer (B) can be linear or branched. Alternatively, the polyoxyalkylene-based polymer (B) can be a mixture of molecules having these structures. Among these, a main chain derived from one or more selected from the group consisting of polyoxypropylene diol and polyoxypropylene triol is particularly preferable.

Examples of the main chain of the polyoxyalkylene-based polymer (B) include those having a repeating unit substantially represented by a general formula (3) “—R⁶—O—” (where “R⁶” is a bivalent alkylene group). Here, the term “substantially” means that the repeating unit represented by the general formula (3) is included in an amount of not less than 50% by weight (preferably not less than 80% by weight), with respect to a total weight of the polyoxyalkylene-based polymer (B).

R⁶ in the general formula (3) is not particularly limited as long as it is a bivalent alkylene group. R⁶ may be an alkylene group having 1 to 14 carbon atoms, or a linear or branched alkylene group having 2 to 4 carbon atoms.

The repeating unit represented by the general formula (3) is not particularly limited. Specific examples thereof include —CH₂O—, —CH₂CH₂O—, —CH₂CH(CH₃)O—, —CH₂CH(C₂H₅)O—, —CH₂C(CH₃)₂O—, and —CH₂CH₂CH₂CH₂O—. Among these, the main chain of the polyoxyalkylene-based polymer (B) may be polypropylene oxide constituted by —CH₂CH(CH₃)O—.

The polyoxyalkylene-based polymer (B) can include a urethane bond or a urea bond in the main chain structure.

A number-average molecular weight of the polyoxyalkylene-based polymer (B) is not particularly limited. The number-average molecular weight may be 5000 or more, 5000 to 50000, or 5000 to 25000. The number-average molecular weight can be measured by, for example, gel permeation chromatography.

(Method for Producing Polyoxyalkylene-Based Polymer (B) Having Alkoxysilyl Group)

A molecular structure of the polyoxyalkylene-based polymer (B) varies depending on purposes of use and intended properties. For example, the compound described in Japanese Patent Application Publication, Tokukaisho, No. 63-112642 can be used as the polyoxyalkylene-based polymer (B). Such a polyoxyalkylene-based polymer (B) can be synthesized by an ordinary polymerization method (anionic polymerization method using caustic alkali). Further, the polyoxyalkylene-based polymer (B) can also be synthesized by a method using a cesium metal catalyst, a porphyrin/aluminum complex catalyst (see Japanese Patent Application Publication, Tokukaisho, No. 61-197631, Japanese Patent Application Publication, Tokukaisho, No. 61-215622, Japanese Patent Application Publication, Tokukaisho, No. 61-215623, Japanese Patent Application Publication, Tokukaisho, No. 61-218632, or the like), a composite metal cyanide complex catalyst (see Japanese Patent Publication, Tokukousho, No. 46-27250, Japanese Patent Publication, Tokukousho, No. 59-15336, or the like), and a catalyst composed of polyphosphazene salt (see Japanese Patent Application Publication Tokukaihei No. 10-273512 or the like).

By employing a method using a porphyrin/aluminum complex catalyst, a composite metal cyanide complex catalyst, or a catalyst constituted by polyphosphazene salt, it is possible to obtain a polyoxyalkylene polymer having a molecular weight distribution (Mw/Mn) of 1.6 or less (preferably 1.5 or less). It is preferable to use the polyoxyalkylene-based polymer (B) having a small molecular weight distribution because viscosity of a curable composition can be lowered while maintaining low modulus and high elongation of a cured product.

(Alkoxysilyl Group)

The alkoxysilyl group included in the polyoxyalkylene-based polymer (B) is not particularly limited. For example, the alkoxysilyl group can be the alkoxysilyl group represented by the general formula (1) described in Section [1]. The alkoxysilyl group included in the polyoxyalkylene-based polymer (B) can have a structure which is identical with or different from that of the alkoxysilyl group included in the (meth)acrylic-based copolymer (A′) and/or the (meth)acrylic-based copolymer (A″).

The number of alkoxysilyl groups included in the polyoxyalkylene-based polymer (B) may be more than 0.5, 1.2 to 6.0, or 1.5 to 2.5 per molecule. In a case where the number of alkoxysilyl groups is within the above range, good curability can be imparted to a curable composition.

The alkoxysilyl group included in the polyoxyalkylene-based polymer (B) may be located at at least one end of the molecule, or at both ends of the molecule. In a case where the alkoxysilyl group is located at the end of the molecule, it is possible to impart good rubber elasticity to a cured product. It is possible to use, in combination, a polyoxyalkylene-based polymer (B) in which an alkoxysilyl group is located at one end of the molecule and a polyoxyalkylene-based polymer (B) in which alkoxysilyl groups are located at both ends of the molecule.

(Method for Introducing Alkoxysilyl Group)

As a method for introducing an alkoxysilyl group into the polyoxyalkylene-based polymer, a conventionally known method can be used. For example, the introduction of an alkoxysilyl group into an oxyalkylene polymer obtained using a composite metal cyanide complex catalyst is described in Japanese Patent Application Publication Tokukaihei No. 3-72527. The introduction of an alkoxysilyl group into an oxyalkylene polymer obtained by using polyphosphazene salt and active hydrogen as a catalyst is described in Japanese Patent Application Publication Tokukaihei No. 11-60723.

In addition, the following introduction methods can be employed.
Method 1: An oxyalkylene polymer having a functional group such as a hydroxyl group at its terminus and an organic compound having an active group exhibiting reactivity with respect to said functional group and an unsaturated group are reacted to obtain an unsaturated group-containing oxyalkylene polymer. Alternatively, an oxyalkylene polymer having a functional group such as a hydroxyl group at its terminus is copolymerized with an unsaturated group-containing epoxy compound to obtain an unsaturated group-containing oxyalkylene polymer. Subsequently, hydrosilane having an alkoxysilyl group is caused to react with the obtained reactant to hydrosilylate the obtained reactant.
Method 2: An unsaturated group-containing oxyalkylene polymer obtained in a manner similar to that in Method 1 is caused to react with a compound having a mercapto group and an alkoxysilyl group.
Method 3: An oxyalkylene polymer having a Y functional group at its terminus is caused to react with a compound having a Y′ functional group and an alkoxysilyl group. Here, the Y functional group is a hydroxyl group, an epoxy group, an isocyanate group, or the like. The Y′ functional group is a functional group that exhibits reactivity with respect to the Y functional group.

Examples of compounds having a Y functional group and an alkoxysilyl group that can be used in Method 3 include amino group-containing silanes (such as γ-(2-aminoethyl)aminopropyltrimethoxysilane, γ-(2-aminoethyl)aminopropylmethyldimethoxysilane, γ-aminopropyltriethoxysilane, 3-amino-2-methylpropyltrimethoxysilane, N-ethyl-3-amino-2-methylpropyltrimethoxysilane, 4-amino-3-methylpropyltrimethoxysilane, 4-amino-3-methylpropylmethyldimethoxysilane, and N-phenyl-3-aminopropyltrimethoxysilane; further, a partial Michael addition reactant of amino group-containing silane with a maleic ester or acrylate compound), mercapto group-containing silanes (such as γ-mercaptopropyltrimethoxysilane and γ-mercaptopropylmethyldimethoxysilane), epoxysilanes (such as γ-glycidoxypropyltrimethoxysilane and β-(3,4-epoxycyclohexyl)ethyltrimethoxysilane), vinyl-type unsaturated group-containing silanes (such as vinyltriethoxysilane, γ-methacrylovloxypropyltrimethoxysilane, and γ-acrylovloxypropylmethyldimethoxysilane), chlorine atom-containing silanes (such as γ-chloropropyltrimethoxysilane), isocyanate-containing silanes (such as γ-isocyanate propyltriethoxysilane, γ-isocyanate propylmethyldimethoxysilane, and γ-isocyanate propyltrimethoxysilane), and hydrosilanes (such as methyldimethoxysilane, trimethoxysilane, methyldiethoxysilane, and triethoxysilane).

(Contained Amount of Polyoxyalkylene-Based Polymer (B) Having Alkoxysilyl Group)

In the curable composition in accordance with one or more embodiments of the present invention, a contained amount of the polyoxyalkylene-based polymer (B) can be adjusted as appropriate. A blending ratio of the (meth)acrylic-based copolymer (A′) and/or the (meth)acrylic-based copolymer (A″) and the polyoxyalkylene-based polymer (B) may be (95/5) to (5/95), (90/10) to (10/90), or (80/20) to (20/80), as represented by the weight ratio. In a case where the blending ratio is within the above range, weather resistance of the cured product can be sufficiently exhibited.

[4.2. Other Additive]

In the curable composition in accordance with one or more embodiments of the present invention, various additives can be contained in addition to the (meth)acrylic-based copolymer (A′) (and/or the (meth)acrylic-based copolymer (A″)) and the polyoxyalkylene-based polymer (B). By incorporating these additives, it is possible to adjust various physical properties of the curable composition and the cured product. Examples of the additive include the following materials. All of those additives can be used alone, or two or more types thereof can be used in combination.

(Tin-Based Curing Catalyst)

The curable composition in accordance with an aspect of one or more embodiments of the present invention can be crosslinked and cured by forming a siloxane bond using a known condensation catalyst. Examples of such a condensation catalyst include a tin-based curing catalyst. Specific examples of the tin-based curing catalyst include dialkyltin carboxylates (such as dibutyltin dilaurate, dibutyltin diacetate, dibutyltin diethylhexanoate, dibutyltin dioctate, dibutyltin dimethylmaleate, dibutyltin diethylmaleate, dibutyltin dibutylmaleate, dibutyltin diisooctyl maleate, dibutyltin ditridecyl maleate, dibutyltin dibenzyl maleate, dibutyltin maleate, dioctyltin diacetate, dioctyltin distearate, dioctyltin dilaurate, dioctyltin diethylmaleate, and dioctyltin diisooctyl maleate); dialkyltin oxides (such as dibutyltin oxide, dioctyltin oxide, a mixture of dibutyltin oxide and phthalate ester); reactants of a tetravalent tin compound (such as dialkyltin oxide and dialkyltin diacetate) with a low-molecular weight silicon compound having an alkoxysilyl group (such as tetraethoxysilane, methyltriethoxysilane, diphenyldimethoxysilane, phenyltrimethoxysilane); bivalent tin compounds (such as tin octylate, tin naphthenate, tin stearate); monoalkyltins (such as monobutyltin compounds (such as monobutyltin trisoctoate and monobutyltin triisopropoxide), and monooctyltin compounds); reactants or mixtures of amine-based compounds with organotin compounds (such as reactants or mixtures of laurylamine and tin octylate); chelate compounds (such as dibutyltin bisacetylacetonate, dioctyltin bisacetylcetonate, dibutyltin bisethylacetate, dioctyltin bisethylacetonate); and tin alcoholates (such as dibutyltin dimethylate, dibutyltin diethylate, dioctyltin dimethylate, and dioctyltin diethylate).

Among these, chelate compounds (such as dibutyltin bisacetylacetonate) and tin alcoholates are preferable because of their high activity as silanol condensation catalysts. In addition, dibutyltin dilaurate is preferable because dibutyltin dilaurate is less colored when being added to the curable composition, is inexpensive, and is easy to obtain.

A contained amount of the tin-based curing catalyst may be 0.1 parts by weight to 20 parts by weight, or 0.5 parts by weight to 10 parts by weight, with respect to the total amount of 100 parts by weight of the (meth)acrylic-based copolymer (A′) (and/or the (meth)acrylic-based copolymer (A″)) and the polyoxyalkylene-based polymer (B).

(Adhesiveness Imparting Agent)

An adhesiveness imparting agent can be added to the curable composition in accordance with one or more embodiments of the present invention. By adding an adhesiveness imparting agent, it is possible to reduce a risk that a sealing material peels off from an adherend such as a siding board (this peeling is caused by variation in joint width or the like due to external force). There is a case where it is not necessary to use a primer for improving adhesiveness. In this case, simplification of construction work is expected.

Examples of the adhesiveness imparting agent include a silane coupling agent. Specific examples of the silane coupling agent include isocyanate group-containing silanes (such as γ-isocyanatepropyltrimethoxysilane, γ-isocyanatepropyltriethoxysilane, γ-isocyanatepropylmethyldiethoxysilane, and γ-isocyanatepropylmethyldimethoxysilane); amino group-containing silanes (such as γ-aminopropyltrimethoxysilane, γ-aminopropyltriethoxysilane, γ-aminopropylmethyldimethoxysilane, γ-aminopropylmethyldiethoxysilane, N-(β-aminoethyl)-γ-aminopropyltrimethoxysilane, N-(β-aminoethyl)-γ-aminopropylmethyldimethoxysilane, N-(β-aminoethyl)-γ-aminopropyltriethoxysilane, N-(β-aminoethyl)-γ-aminopropylmethyldiethoxysilane, γ-ureidopropyltrimethoxysilane, N-phenyl-γ-aminopropyltrimethoxysilane, N-benzyl-γ-aminopropyltrimethoxysilane, and N-vinylbenzyl-γ-aminopropyltriethoxysilane); mercapto group-containing silanes (such as γ-mercaptopropyltrimethoxysilane, γ-mercaptopropyltriethoxysilane, γ-mercaptopropylmethyldimethoxysilane, and γ-mercaptopropylmethyldiethoxysilane); carboxysilanes (such as β-carboxyethyltriethoxysilane, β-carboxyethylphenylbis(2-methoxyethoxy)silane, and N-(β-carboxymethyl)aminoethyl-γ-aminopropyltrimethoxysilane); vinyl-type unsaturated group-containing silanes (such as vinyltrimethoxysilane, vinyltriethoxysilane, γ-methacryloyloxypropylmethyldimethoxysilane, and γ-acroyloxypropylmaethvltriethoxysilane); halogen-containing silanes (such as γ-chloropropyltrimethoxysilane); and isocyanurate silanes (such as tris(trimethoxysilyl)isocyanurate). Moreover, an amino-modified silyl polymer, a silylated amino polymer, an unsaturated aminosilane complex, a phenylamino long-chain alkylsilane, an aminosilylated silicone, a silylated polyester, and the like, which are derivatives obtained by modifying a silane coupling agent, can also be used as a silane coupling agent.

A contained amount of the adhesiveness imparting agent may be 0.1 parts by weight to 20 parts by weight, or 0.5 parts by weight to 10 parts by weight, with respect to the total amount of 100 parts by weight of the (meth)acrylic-based copolymer (A′) (and/or the (meth)acrylic-based copolymer (A″)) and the polyoxyalkylene-based polymer (B).

(Plasticizer)

The curable composition in accordance with one or more embodiments of the present invention can contain a plasticizer. In a case where a plasticizer and a filler (described later) are used in combination, elongation of the cured product becomes larger, and a larger amount of filler can be mixed.

Examples of the plasticizer include phthalate esters (such as dibutyl phthalate, diheptyl phthalate, di(2-ethylhexyl)phthalate, diisodecyl phthalate, and butyl benzyl phthalate); non-aromatic dibasic acid esters (such as dioctyl adipate, dioctyl sebacate, dibutyl sebacate, and isodecyl succinate); aliphatic esters (such as butyl oleate and methyl acetylricinoleate); esters of polyalkylene glycol (such as diethylene glycol dibenzoate, triethylene glycol dibenzoate, and pentaerythritol ester); phosphate esters (such as tricresyl phosphate and tributyl phosphate); trimellitic acid esters; polystyrenes (such as polystyrene, poly-α-methylstyrene); polybutadiene; polybutene, polyisobutylene; butadiene-acrylonitrile; polychloroprene; chlorinated paraffins; hydrocarbon-based oils (such as alkyldiphenyl and partial hydrogenated terphenyl); process oils; polyethers (polyether polyols (such as polyethylene glycol, polypropylene glycol, and polytetramethylene glycol), and derivatives obtained by converting hydroxyl groups of polyether polyols into ester groups, ether groups, and the like); polyester-based plasticizers obtained from dibasic acid and dihydric alcohol (such as polyesters obtained from sebacic acid, adipic acid, azelaic acid, phthalic acid, and the like, and ethylene glycol, diethylene glycol, triethylene glycol, propylene glycol, dipropylene glycol, and the like); and vinyl-based polymers (obtained by polymerizing vinyl-based monomers such as acrylic plasticizer in various manners).

The acrylic plasticizer can be prepared by a high temperature continuous polymerization method without using a solvent and a chain transfer agent (see Specification of U.S. Pat. No. 4,414,370, Japanese Patent Application Publication, Tokukaisho, No. 59-6207, Japanese Examined Patent Application Publication, Tokukouhei, No. 5-58005, Japanese Patent Application Publication Tokukaihei No. 1-313522, and Specification of U.S. Pat. No. 5,010,166). Specific examples of the acrylic plasticizer include ARUFON UP-1000, UP-1020, and UP-1110 (which are available from TOAGOSEI CO., LTD.), JDX-P1000, JDX-P1010, and JDX-P1020 (which are available from Johnson Polymer). It is possible to use an acrylic-based reactive plasticizer having an alkoxysilyl group. Specific examples of such a plasticizer include ARFUON US-6100.

A contained amount of the plasticizer may be 5 parts by weight to 800 parts by weight, 10 parts by weight to 600 parts by weight, or 10 parts by weight to 500 parts by weight, with respect to the total amount of 100 parts by weight of the (meth)acrylic-based copolymer (A′) (and/or the (meth)acrylic-based copolymer (A″)) and the polyoxyalkylene-based polymer (B).

(Filler)

The curable composition in accordance with one or more embodiments of the present invention can contain a filler. Examples of the filler include wood flour; reinforcing fillers (such as pulp, cotton tips, asbestos, mica, walnut shell flour, chaff flour, graphite, white clay, silica (fumed silica, precipitated silica, crystalline silica, fused silica, dolomite, silicic anhydride, hydrous silicic acid, and the like), and carbon black); fillers (such as heavy calcium carbonate, colloidal calcium carbonate, magnesium carbonate, siliceous earth, calcined clay, clay, talc, titanium oxide, bentonite, organic: bentonite, ferric oxide, red iron oxide, aluminum fine powder, flint powder, zinc oxide, activated zinc oxide, zinc powder, zinc carbonate, and shirasu balloon); and fibrous fillers (such as asbestos, glass fibers and glass filaments, carbon fibers, kevlar fibers, and polyethylene fibers).

A contained amount of the filler may be 5 parts by weight to 5000 parts by weight, 10 parts by weight to 2500 parts by weight, or 15 parts by weight to 1500 parts by weight, with respect to the total amount of 100 parts by weight of the (meth)acrylic-based copolymer (A′) (and/or the (meth)acrylic-based copolymer (A″)) and the polyoxyalkylene-based polymer (B).

(Property Adjusting Agent)

The curable composition in accordance with one or more embodiments of the present invention can contain a property adjusting agent for adjusting tensile characteristics of the cured product. By using the property adjusting agent, it is possible to increase hardness of the cured product or, conversely, to lower the hardness such that the cured product can elongate.

Examples of the property adjusting agent include alkylalkoxysilanes (such as methyltrimethoxysilane, dimethyldimethoxysilane, trimethylmethoxysilane, and n-propyltrimethoxysilane); alkylisopropenoxysilanes (such as dimethyldiisopropenoxysilane and methyltriisopropenoxysilane); alkoxysilanes having a functional group (such as vinyldimethylmethoxysilane, γ-aminopropyltrimethoxysilane, N-(β-aminoethyl)aminopropylmethyldimethoxysilane, γ-mercaptopropyltrimethoxysilane, and γ-mercaptopropylmethyldimethoxysilane); silicone varnishes; and polysiloxanes.

A contained amount of the property adjusting may be 0.1 parts by weight to 80 parts by weight, or 0.1 parts by weight to 50 parts by weight, with respect to the total amount of 100 parts by weight of the (meth)acrylic-based copolymer (A′) (and/or the (meth)acrylic-based copolymer (A″)) and the polyoxyalkylene-based polymer (B).

(Thixotropy Imparting Agent (Anti-Sagging Agent))

The curable composition in accordance with one or more embodiments of the present invention can contain a thixotropy imparting agent (anti-sagging agent) in order to prevent sagging and to improve workability.

Examples of the thixotropy imparting agent include polyamide waxes; hydrogenated castor oil derivatives; and metallic soaps (such as calcium stearate, aluminum stearate, and barium stearate).

A contained amount of the thixotropy imparting agent may be 0.1 parts by weight to 50 parts by weight, or 0.2 parts by weight to 25 parts by weight, with respect to the total amount of 100 parts by weight of the (meth)acrylic-based copolymer (A′) (and/or the (meth)acrylic-based copolymer (A″)) and the polyoxyalkylene-based polymer (B).

(Photocurable Substance)

The curable composition in accordance with one or more embodiments of the present invention can contain a photocurable substance. The photocurable substance is a substance that undergoes a chemical change in a short time due to an action of light, and thus causes a change in physical properties (such as curing). By incorporating the photocurable substance, adhesiveness (residual tack) on the cured product surface can be reduced. A typical photocurable substance can be cured, for example, by being left to stand at room temperature for 1 day in a sunny spot in a room (e.g., near a window). As the photocurable substance, many materials are known, such as organic monomers, oligomers, resins and compositions containing those. A type of the photocurable substance is not particularly limited. Examples of the photocurable substance include unsaturated acrylic compounds, polyvinyl cinnamates, and azidated resins.

Specific examples of the unsaturated acrylic compound include (meth)acrylic esters of low molecular weight alcohols (such as ethylene glycol, glycerin, trimethylolpropane, pentaerythritol, neopentyl alcohol); (meth)acrylic esters of alcohols in which an acid (bisphenol A, isocyanuric acid), a low molecular weight alcohol, or the like is modified with ethylene oxide, propylene oxide, or the like; (meth)acrylic esters (such as polyether polyol in which the main chain is polyether and has a hydroxyl group at its terminus, polymer polyol obtained by radical polymerization of a vinyl-based monomer in polyol in which the main chain is polyether, polyester polyol in which the main chain is polyester and has a hydroxyl group at its terminus, and polyol in which the main chain is a vinyl-based or (meth)acrylic polymer and has a hydroxyl group in its main chain); epoxy acrylate-based oligomers obtained by reacting an epoxy resin (such as of bisphenol A type or novolac type) with (meth)acrylic acid; urethane acrylate-based oligomers having a urethane bond and a (meth)acrylic group in a molecular chain obtained by reacting polyol, polyisocyanate, a hydroxyl group-containing (meth)acrylate, or the like.

A contained amount of the photocurable substance may be 0.01 parts by weight to 30 parts by weight, with respect to the total amount of 100 parts by weight of the (meth)acrylic-based copolymer (A′) (and/or the (meth)acrylic-based copolymer (A′)) and the polyoxyalkylene-based polymer (B).

(Air-Oxidation-Curable Substance)

The curable composition in accordance with one or more embodiments of the present invention can contain an air-oxidation-curable substance. The air-oxidation-curable substance refers to a compound having an unsaturated group which can be crosslinked and cured by oxygen in air. By incorporating the air-oxidation-curable substance, adhesiveness (residual tack) on the cured product surface can be reduced. A typical air-oxidation-curable substance can be cured, for example, by being left to stand in air for 1 day in a room.

Examples of the air-oxidation-curable substance include dry oils (such as tung oil and linseed oil); various alkyd resins obtained by modifying dry oils; substances obtained by modifying an acrylic polymer, a silicone resin, or the like with dry oil; 1,2-polybutadiene; 1,4-polybutadiene; polymers or copolymers of C5-C8 dienes; various modified products of polymers or copolymers of C5-C8 dienes (such as maleic modified product and boiled oil modified product). Among those described above, tung oil, a diene-based polymer liquid and a modified product thereof are preferable.

A contained amount of the air-oxidation-curable substance may be 0.01 parts by weight to 30 parts by weight, with respect to the total amount of 100 parts by weight of the (meth)acrylic-based copolymer (A′) (and/or the (meth)acrylic-based copolymer (A″)) and the polyoxyalkylene-based polymer (B).

(Antioxidant and Photo Stabilizer)

The curable composition in accordance with one or more embodiments of the present invention can contain an antioxidant and/or a photo stabilizer. Various types of antioxidants and photo stabilizers are known. Examples thereof include substances listed in [“SANKABOUSHIZAI HANDBOOK (Antioxidant Handbook)” by Kenichi Saruwatari, et al., Taiseisha, 1976], [“KOUBUNSHIZAIRYOU NO REKKA TO ANTEIKA (Deterioration and Stabilization of Polymer Materials)” supervised by Zenjiro Ozawa, CMC Publishing Co., Ltd., 1990, pp. 235-242], and the like.

Examples of the antioxidant include thioether-based antioxidants such as ADK STAB PEP-36 and ADK STAB AO-23 (which are available from Asahi Denka Kogyo Kabushiki Kaisha); phosphorus-based antioxidants such as Irgafos38, Irgafos168, and IrgafosP-EPQ (which are available from Ciba Specialty Chemicals Corporation); and hindered phenol-based antioxidants. Among those described above, a hindered phenol-based antioxidant is preferable.

Specific examples of the hindered phenol-based antioxidant include 2,6-di-t-butyl-4-methylphenol, 2,6-di-t-butyl-4-ethylphenol, mono (or di or tri) (a methylbenzyl)phenol, 2,2′-methylenebis(4ethyl-6-t-butylphenol), 2,2′-methylenebis(4methyl-6-t-butylphenol), 4,4′-butylidenebis(3-methyl-6-t-butylphenol), 4,4′-thiobis(3-methyl-6-t-butylphenol), 2,5-di-t-butyl hydroquinone, 2,5-di-t-amyl hydroquinone, triethylene glycol-bis-[3-(3-t-butyl-5-methyl-4hydroxyphenyl)propionate], 1,6-hexanediol-bis[3-(3,5-di-t-butyl-4-hydroxyphenyl)propionate], 2,4-bis-(n-octylthio)-6-(4-hydroxy-3,5-di-t-butylanilino)-1,3,5-triazine, pentaerythrityl-tetrakis[3-(3,5-di-t-butyl-4-hydroxyphenyl)propionate], 2,2-thio-diethylenebis[3-(3,5-di-t-butyl-4-hydroxyphenyl)propionate], octadecyl-3-(3,5-di-t-butyl-4-hydroxyphenyl)propionate, N,N′-hexamethylene bis(3,5-di-t-butyl-4-hydroxy-hydrocinnamamide), 3,5-di-t-butyl-4-hydroxy-benzylphosphonate-diethyl ester, 1,3,5-trimethyl-2,4,6-tris(3,5-di-t-butyl-4-hydroxybenzyl)benzene, bis(ethyl 3,5-di-t-butyl-4-hydroxybenzylphosphonate)calcium, tris-(3,5-di-t-butyl-4-hydroxybenzyl)isocyanurate, 2,4-bis[(octylthio)methyl]o-cresol, N,N′-bis[3-(3,5-di-t-butyl-4-hydroxyphenyl)propionyl]hydrazine, tris(2,4-di-t-butylphenyl)phosphite, 2-(5-methyl-2-hydroxyphenyl)benzotriazole, 2-[2-hydroxy-3,5-bis(α,α-dimethylbenzyl)phenyl]-2H-benzotriazole, 2-(3,5-di-t-butyl-2-hydroxyphenyl)benzotriazole, 2-(3-t-butyl-5-methyl-2-hydroxyphenyl)-5-chlorobenzotriazole, 2-(3,5-di-t-butyl-2-hydroxyphenyl)-5-chlorobenzotriazole, 2-(3,5-di-t-amyl-2-hydroxyphenyl)benzotriazole, 2-(2′-hydroxy-5′-t-octylphenyl)-benzotriazole, methyl-3-[3-t-butyl-5-(2H-benzotriazol-2-yl)-4-hydroxyphenyl]propionate-polyethylene glycol condensate (with a molecular weight of approximately 300), hydroxyphenylbenzotriazole derivative, 2-(3,5-di-t-butyl-4-hydroxybenzyl)-2-n-butylmalonate bis(1,2,2,6,6-pentamethyl-4-piperidyl), and 2,4-di-t-butylphenyl-3,5-di-t-butyl-4-hydroxybenzoate.

Examples of commercially available antioxidants include NOCRAC 200, NOCRAC M-17, NOCRAC SP, NOCRAC SP-N, NOCRAC NS-5, NOCRAC NS-6, NOCRAC NS-30, NOCRAC 300, NOCRAC NS-7, NOCRAC DAH (which are all available from Ouchi Shinko Chemical Industrial Co., Ltd.); ADK STAB AO-30, ADK STAB AO-40, ADK STAB AO-50, ADK STAB AO-60, ADK STAB AO-616, ADK STAB AO-635, ADK STAB AO-658, ADK STAB AO-80, ADK STAB AO-15, ADK STAB AO-18, ADK STAB 328, ADK STAB AO-37 (which are all available from Asahi Denka Kogyo Kabushiki Kaisha); IRGANOX-245, IRGANOX-259, IRGANOX-565, IRGANOX-1010, IRGANOX-1024, IRGANOX-1035, IRGANOX-1076, IRGANOX-1081, IRGANOX-1098, IRGANOX-1222, IRGANOX-1330, IRGANOX-1425WL (which are all available from Ciba Specialty Chemicals Corporation); and SumilizerGM, SumilizerGA-80, and SumilizerGS (which are all available from Sumitomo Chemical Company, Limited).

Examples of the photo stabilizer include benzotriazole-based compounds such as UV absorbents (Tinuvin P, Tinuvin 234, Tinuvin 320, Tinuvin 326, Tinuvin 327, Tinuvin 329, Tinuvin 213, which are all available from Ciba Specialty Chemicals Corporation); triazine-based photo stabilizers such as Tinuvin 1577; benzophenone-based compounds such as CHIMASSORB81; benzoate-based compounds such as Tinuvin 120 (available from Ciba Specialty Chemicals Corporation); and hindered amine-based compounds). Among those described above, a hindered amine-based compound is preferable.

Specific examples of the hindered amine-based compound include a dimethyl-1-(2-hydroxyethyl)-4-hydroxy-2,2,6,6-tetramethylpiperidine succinate polycondensate, poly[{6-(1,1,3,3-tetramethylbutyl)amino-1,3,5-triazine-2,4-diyl}{(2,2,6,6-tetramethyl-4-piperidyl)imino}], an N,N′-bis(3aminopropyl)ethylenediamine-2,4-bis[N-butyl-N-(1,2,2,6,6-pentamethyl-4-piperidyl)amino]-6-chloro-1,3,5-triazine condensate, bis(2,2,6,6-tetramethyl-4-piperidyl)sebacate, and bis(2,2,6,6-tetramethyl-4-piperidinyl) succinate.

Examples of commercially available photo stabilizers include Tinuvin 622LD, Tinuvin 144, CHIMASSORB944LD, and CHIMASSORB119FL (which are all available from Ciba Specialty Chemicals Corporation); ADK STAB LA-52, ADK STAB LA-57, ADK STAB LA-62, ADK STAB LA-67, ADK STAB LA-63, ADK STAB LA-68, ADK STAB LA-82, and ADK STAB LA-87 (which are all available from Asahi Denka Kogyo Kabushiki Kaisha); and SANOL LS-770, SANOL LS-765, SANOL LS-292, SANOL LS-2626, SANOL LS-1114, SANOL LS-744, and SANOL LS-440 (which are all available from SANKYO).

An antioxidant and a photo stabilizer can be used in combination. In a case where the antioxidant and the photo stabilizer are used in combination, it is possible that respective effects thereof are further improved, and heat resistance, weather resistance, and the like of the cured product would be improved. For example, in order to improve weather resistance, a UV absorbent and a hindered amine-based compound (HALS) can be combined. This combination can further improve effects of the respective agents, and is preferable.

A contained amount of each of the antioxidant and/or the photo stabilizer may be 0.1 parts by weight to 20 parts by weight, with respect to the total amount of 100 parts by weight of the (meth)acrylic-based copolymer (A′) (and/or the (meth)acrylic-based copolymer (A″)) and the polyoxyalkylene-based polymer (B).

[4.3. Form of Curable Composition]

The curable composition in accordance with one or more embodiments of the present invention can be a one-component type or a two-component type. A curable composition of the one-component type is a curable composition in which all of components are blended in advance and then stored in a sealed manner. The curable composition of the one-component type is cured by moisture in the air after use. Meanwhile, for the curable composition of the two-component type, a curing agent containing components such as a curing catalyst, a filler, a plasticizer, and water is separately prepared. The curable composition of the two-component type is used by mixing the curing agent and a main agent containing the (meth)acrylic-based copolymer (A′) and/or the (meth)acrylic-based copolymer (A″). Note that the curable composition of the two-component type can contain an agent (such as a colorant) in addition to the main agent and the curing agent.

In a case where the curable composition is prepared as the two-component type, a colorant can be further added at the time of mixing the two components. This makes it possible, for example, to provide, from limited types of curable compositions, any of a wide variety of colors of sealing material in accordance with a color of a siding board. Therefore, the curable composition of the two-component type can easily meet demands for multicoloration from the market, and is suitable for low-rise building applications and the like. As the colorant, for example, a colorant may be in a paste form obtained by mixing a pigment, a plasticizer, and, if necessary, a filler, because of high workability.

For the curable composition of the two-component type, a retarder can be added at the time of mixing the two components. This makes it possible to carry out fine adjustment of a curing rate at a work site.

[5. Cured Product]

A cured product in accordance with one or more embodiments of the present invention is obtained by curing a composition containing the (meth)acrylic-based copolymer (A′) and/or the (meth)acrylic-based copolymer (A″) and the epoxy compound (C). A cured product in accordance with one or more embodiments of the present invention is obtained by curing a curable composition containing the (meth)acrylic-based copolymer (A′) and/or the (meth)acrylic-based copolymer (A″), the polyoxyalkylene-based polymer (B), and the epoxy compound (C). That is, in the cured product, the polyoxyalkylene-based polymer (B) is an optional component and does not necessarily need to be contained.

There is no particular limitation on application of the composition, the curable composition and the cured product in accordance with one or more embodiments of the present invention. Examples of the application include sealing materials for architectural and industrial applications (such as a sealing material for siding boards, a sealing material for double glazing, and a sealing material for vehicles, in addition to an elastic sealing material for durable architectural applications used in working joints), materials for electrical and electronic components (such as a solar cell backside sealant), electrical insulating materials (such as insulation covering materials for electric wires and cables), an adhesive, an adhesive agent, an elastic adhesive agent, a contact adhesive agent, an adhesive agent for tiles, a reactive hot-melt adhesive agent, a paint, a powder paint, a coating material, foam, sealing materials such as a can lid, a potting agent for electrical and electronic applications, a film, a gasket, a casting material, various molding materials, artificial marble, rust-proof and/or water-proof sealing materials for cut sections of wired glass and laminated glass, vibration-proof, vibration-damping, noise-proof, and/or seismic-isolation materials (used in automobiles, ships, home appliances, and the like), liquid sealing agents (used in automotive parts, electrical parts, various mechanical parts, and the like), and a waterproofing agent.

Among those described above, the composition, the curable composition and the cured product in accordance with one or more embodiments of the present invention are particularly useful as the sealing material and the adhesive agent. In particular, the composition, the curable composition and the cured product are useful in applications requiring weather resistance or durability, or in applications requiring transparency. The curable composition and the cured product in accordance with one or more embodiments of the present invention are excellent in weather resistance and adhesiveness, and therefore can be used for an outer wall tile bonding method without filling of joints. The curable composition and the cured product are also useful in elastic adhesive agent applications for bonding materials with differing linear expansion coefficients and for bonding members that are repeatedly displaced by heat cycle. In addition, the curable composition and the cured product are also useful, by utilizing transparency, as a coating agent in applications in which a base is visible, and as an adhesive agent for use in bonding transparent materials (such as glass, polycarbonate, methacrylic resin) together.

Aspects of one or more embodiments of the present invention can also be expressed as follows:

One or more embodiments of the present invention encompass the following aspects:

<1>

A composition containing a (meth)acrylic-based copolymer (A′) and an epoxy compound (C), in which:

the (meth)acrylic-based copolymer (A′) has an X block and a Y block;

a molecule of the (meth)acrylic-based copolymer (A′) includes an XY diblock structure or an XYX triblock structure therein;

the number of repeating units which are derived from a (meth)acrylic ester monomer having an alkoxysilyl group and are included in the X block is 1.0 or more on average;

an amount of repeating units which are derived from a (meth)acrylic ester monomer having an alkoxysilyl group and are included in the Y block is 0% by weight to 3% by weight, with respect to a weight of all repeating units included in the Y block; and

a molecular weight distribution (Mw/Mn) of the (meth)acrylic-based copolymer (A′) is 1.8 or less.

<2>

The composition described in <0.1>, in which the (meth)acrylic-based copolymer (A′) is a (meth)acrylic-based copolymer (A″) that satisfies the following conditions:

the (meth)acrylic-based copolymer (A′) randomly includes repeating units derived from a (meth)acrylic ester monomer (α);

the (meth)acrylic ester monomer (α) has an alkyl group that is coupled to (meth)acrylic acid via an ester bond, and the alkyl group has an alkoxy group having 1 to 5 carbon atoms; and

the repeating units derived from the (meth)acrylic ester monomer (α) are included in an amount of 5% by weight to 20% by weight, with respect to a weight of all repeating units included in the (meth)acrylic-based copolymer (A″).

<3>

The composition described in <2>, in which: the (meth)acrylic ester monomer (α) is one or more selected from the group consisting of 2-methoxyethyl (meth)acrylate, 2-ethoxyethyl (meth)acrylate, 2-butoxyethyl (meth)acrylate, and isopropoxyethyl (meth)acrylate.

<4>

The composition described in any of <1> through <3>, in which: an amount of the repeating units which are derived from the (meth)acrylic ester monomer having the alkoxysilyl group and are included in the X block is more than 3% by weight, with respect to a weight of all repeating units included in the X block.

<5>

The composition described in any of <1> through <4>, in which:

the (meth)acrylic-based copolymer (A′) includes repeating units derived from a (meth)acrylic ester monomer (β) and a (meth)acrylic acid monomer (γ) in a total amount of 45% by weight to 96% by weight, and repeating units derived from a (meth)acrylic ester monomer (δ) in an amount of 4% by weight to 35% by weight, with respect to a weight of all repeating units;

in the (meth)acrylic ester monomer (β), the number of carbon atoms of an alkyl group coupled to (meth)acrylic acid via an ester bond is 1 to 5;

in the (meth)acrylic ester monomer (γ), the number of carbon atoms of an alkyl group coupled to (meth)acrylic acid via an ester bond is 6 to 15; and

in the (meth)acrylic ester monomer (δ), the number of carbon atoms of alkyl coupled to (meth)acrylic acid via an ester bond is 16 to 25.

<6>

The composition described in <5>, in which: the (meth)acrylic ester monomer (δ) is one or more selected from the group consisting of pentadecyl (meth)acrylate, hexadecyl (meth)acrylate, heptadecyl (meth)acrylate, octadecyl (meth)acrylate, icosyl (meth)acrylate, and docosyl (meth)acrylate.

<7>

The composition described in any of <1> through <6>, in which:

a contained amount of the (meth)acrylic-based copolymer (A′) and/or the (meth)acrylic-based copolymer (A″) is 50% by weight to 99.9% by weight; and

a contained amount of the epoxy compound (C) is 0.1% by weight to 50% by weight.

<8>

The composition described in any of <1> through <7>, in which: the epoxy compound (C) is one or more selected from the group consisting of epoxidized unsaturated fats and oils, an epoxy plasticizer, and monoepoxide.

<9>

A curable composition, including:

the composition described in any of <0.1> through <8>; and a polyoxyalkylene-based polymer (B) having an alkoxysilyl group.

<10>

A cured product which is obtained by curing a composition described in any of <1> through <8> or a curable composition described in <9>.

<11>

A sealing material or an adhesive agent, containing:

a composition described in any one of <1> through <8>;

a curable composition described in <9>; or

a cured product described in <10>.

<12>

A method for storing a (meth)acrylic-based copolymer (A′) and/or a (meth)acrylic-based copolymer (A″), the method including the step of preparing a composition described in any of <1> through <8>, in which:

a contained amount of the (meth)acrylic-based copolymer (A′) and/or the (meth)acrylic-based copolymer (A″) in the composition is 50% by weight to 99.9% by weight; and

a contained amount of the epoxy compound (C) in the composition is 0.1% by weight to 50% by weight.

<13>

The method described in <12>, in which: a viscosity increase ratio of the composition is 65% or less, after storage for 4 weeks at 80° C.

<14>

A method for producing the composition described in <1>, the method including a step 1a, a step 2a, and a step 3a, or including a step 1b, a step 2b, and a step 3b, in which:

the step 1a is a step of polymerizing a (meth)acrylic ester monomer mixture with use of a living polymerization initiator, the (meth)acrylic ester monomer mixture containing more than 3% by weight of the (meth)acrylic ester monomer having the alkoxysilyl group;

the step 2a is a step of adding, to a reaction system after the step 1a, a (meth)acrylic ester monomer mixture containing 0% by weight to 3% by weight of the (meth)acrylic ester monomer having the alkoxysilyl group, and polymerizing the reaction system;

the step 3a is a step of mixing the epoxy compound (C) with the (meth)acrylic-based copolymer (A′) which has been obtained through the step 2a and an optionally added polymerization process;

the step 1b is a step of polymerizing a (meth)acrylic ester monomer mixture with use of a living polymerization initiator, the (meth)acrylic ester monomer mixture containing 0% by weight to 3% by weight of the (meth)acrylic ester monomer having the alkoxysilyl group;

the step 2b is a step of adding, to a reaction system after the step 1b, a (meth)acrylic ester monomer mixture containing more than 3% by weight of the (meth)acrylic ester monomer having the alkoxysilyl group, and polymerizing the reaction system; and

the step 31) is a step of mixing the epoxy compound (C) with the (meth)acrylic-based copolymer (A′) which has been obtained through the step 2b and an optionally added polymerization process.

<15>

The method described in <14>, in which: the living polymerization initiator is a living radical polymerization initiator.

Moreover, one or more embodiments of the present invention also encompass the following aspects:

<1a>

In the composition, a total weight of repeating units derived from the (meth)acrylic ester monomer contained in the (meth)acrylic-based copolymer (A′) and/or the (meth)acrylic-based copolymer (A″) can be not less than 70% by weight, or can be not less than 90% by weight, with respect to a weight of all repeating units included in the (meth)acrylic-based copolymer (A′) and/or the (meth)acrylic-based copolymer (A″).

<2a>

In the composition, the (meth)acrylic ester monomer (β) can be butyl acrylate.

<3a>

In the composition, the (meth)acrylic ester monomer (γ) can be one or more selected from the group consisting of 2-ethylhexyl acrylate and dodecyl acrylate.

<4a>

In the composition, the (meth)acrylic ester monomer (5) can be octadecyl acrylate.

<5a>

In the composition, a number-average molecular weight of the (meth)acrylic-based copolymer (A′) and/or the (meth)acrylic-based copolymer (A″) measured by gel permeation chromatography can be 4,000 or more, or can be 30,000 or more. The number-average molecular weight can be 80,000 or less.

<6a>

In the composition, the (meth)acrylic-based copolymer (A′) and/or the (meth)acrylic-based copolymer (A″) can contain 10.0 or less alkoxysilyl groups on average per molecule.

<7a>

In the curable composition, a blending ratio between the (meth)acrylic-based copolymer (A′) and/or the (meth)acrylic-based copolymer (A″) and the polyoxyalkylene-based polymer (B) having an alkoxysilyl group can be (95/5) to (5/95).

<8a>

In the curable composition, one or more selected from the group consisting of the (meth)acrylic-based copolymer (A′), the (meth)acrylic-based copolymer (A″), and the polyoxyalkylene-based polymer (B) having an alkoxysilyl group can have an alkoxysilyl group represented by the following general formula (1):

—[Si(R¹)_{2-b}(Y)_{b}O]ₘ—Si(R²)₃₋ₐ(Y)ₐ (1)

where

“R¹” and “R²” are independently an alkyl group having 1 to 20 carbon atoms, an aryl group having 6 to 20 carbon atoms, an aralkyl group having 7 to 20 carbon atoms, a methoxymethyl group, or a triorganosiloxy group represented by (R′)₃SiO—,

“R′” is a monovalent hydrocarbon group having 1 to 20 carbon atoms, and three R′ groups present can be the same or different,

in a case where two or more R¹ or R² groups are present, the R¹ or R² groups can be the same or different,

“Y” is an alkoxy group having 1 to 20 carbon atoms,

in a case where two or more Y groups are present, the Y groups can be the same or different,

“a” is 0, 1, 2 or 3,

“b” is 0, 1 or 2,

“m” is an integer of 0 to 19, and

a+mb≥1.

Furthermore, one or more embodiments of the present invention also encompass the following aspects:

<1b>

A method for storing a (meth)acrylic-based copolymer (A′) for 168 hours or more at 50° C. or higher, in which:

the (meth)acrylic-based copolymer (A′) is stored in a form of a composition containing an epoxy compound (C);

the (meth)acrylic-based copolymer (A′) has an X block and a Y block;

the (meth)acrylic-based copolymer (A′) includes an XY diblock structure or an XYX triblock structure;

the number of repeating units which are derived from a (meth)acrylic ester monomer having an alkoxysilyl group and are included in the X block is 1.0 or more on average;

an amount of repeating units which are derived from a (meth)acrylic ester monomer having an alkoxysilyl group and are included in the Y block is 0% by weight to 3% by weight, with respect to a weight of all repeating units included in the Y block; and

a molecular weight distribution (Mw/Mn) of the (meth)acrylic-based copolymer (A′) is 1.8 or less.

<2b>

The method described in <1b>, in which:

the (meth)acrylic-based copolymer (A′) randomly includes repeating units derived from a (meth)acrylic ester monomer (α);

the (meth)acrylic ester monomer (α) has an alkyl group that is coupled to (meth)acrylic acid via an ester bond, and the alkyl group has an alkoxy group having 1 to 5 carbon atoms; and

the repeating units derived from the (meth)acrylic ester monomer (α) are included in an amount of 5% by weight to 20% by weight, with respect to a weight of all repeating units included in the (meth)acrylic-based copolymer (A′).

The contents described in the above items can be applied to other items as appropriate. One or more embodiments of the present invention are not limited to the embodiments, but can be altered variously by a skilled person in the art within the scope of the claims. Therefore, one or more embodiments of the present invention also encompass, in their technical scope, any embodiments derived by appropriately combining technical means disclosed in differing embodiments.

All scientific literatures and patent literatures described in this specification are incorporated herein as reference literatures.

The following description will discuss one or more embodiments of the present invention in further detail with reference to Examples. Note, however, that one or more embodiments of the present invention are not limited only to those Examples.

### EXAMPLES

### Production Example 1: Production of (Meth)Acrylic-Based Copolymer (A″)-1

(Preparation)

A 2000-mL three-necked flask was prepared. In this flask, (meth)acrylic ester monomers (α), (β) and (δ) were mixed in a proportion indicated in Table 1. Specifically, 700 g of n-butyl acrylate, 110 g of 2-methoxyethyl acrylate, and 190 g of octadecyl acrylate (total: 1000 g) were mixed. This mixture is referred to as “(meth)acrylic ester monomer mixture”.

Next, another stirring container was prepared. To the container, 52.7 mg of cupric bromide (CuBr₂), 54.4 mg of hexamethyltris(2-aminoethyl)amine (Me₆TREN), and 1.82 g of methanol were introduced, and were then stirred under a nitrogen gas stream until a homogeneous solution was obtained. This homogeneous solution is referred to as “copper solution”. Note that copper contained in the copper solution is equivalent to 15 ppm, with respect to a total amount of the (meth)acrylic ester monomer mixture.

In addition, still another stirring container was prepared. To this container, 30.8 mL of methanol, 1.0 g of ascorbic acid, and 1.58 mL of triethylamine were introduced, and were then stirred under a nitrogen gas stream for 30 minutes to obtain a homogeneous solution. This homogeneous solution is referred to as “ascorbic acid solution”.

(First Step)

To a stirrer, 5.84 g of ethyl α-bromobutyrate (initiator; 0.030 mol), 200 g of the (meth)acrylic ester monomer mixture (20% by weight of the total amount), 13.93 g of 3-(trimethoxysilyl)propyl methacrylate (0.060 mol; 1.93 molar equivalent with respect to the initiator), 151.76 g of methanol (available from Wako Pure Chemical Industries, Ltd.), and the all amount of the copper solution were introduced, and were then stirred under a nitrogen gas stream for 30 minutes to obtain a homogeneous solution. The stirrer used at this time was a stirring device with jacket temperature control, and a jacket temperature was set at 45° C.

Next, when a temperature in a polymerization system became 40° C. or higher, a polymerization reaction was initiated by continuously dripping the ascorbic acid solution. At this time, a dripping rate of the ascorbic acid solution was defined as a rate at which 144 mg of ascorbic acid was introduced into the polymerization system per hour.

When the temperature in the polymerization system was monitored, the temperature increased at the same time as the start of the dripping of ascorbic acid, and after reaching the maximum temperature, the temperature gradually decreased. At the time when a temperature difference obtained by subtracting the jacket temperature from the temperature in the polymerization system became 1° C., the reaction solution in the polymerization system was sampled in a small amount and analyzed by gas chromatography. Consequently, among the initially introduced (meth)acrylic ester monomer mixture, 90% by weight thereof had been consumed.

(Second Step)

Next, the remainder of the (meth)acrylic ester monomer mixture (80% by weight of the total amount) that was not introduced in the first step was continuously dripped into the polymerization system over a period of 150 minutes. At this time, the dripping rate of the ascorbic acid solution was defined as a rate at which 48 mg of ascorbic acid was introduced into the polymerization system per hour. After completion of the dripping of the (meth)acrylic ester monomer mixture, the dripping rate of the ascorbic acid solution was defined as a rate at which 60 mg of ascorbic acid was introduced into the polymerization system per hour. Sampling was also carried out sequentially, and the samples were analyzed by gas chromatography. Then, the polymerization was continued until 94% by weight of the total amount of the (meth)acrylic ester monomer mixture introduced to the polymerization system was consumed.

(Third Step)

Next, 15.32 g (0.066 mol) of 3-(trimethoxysilyl)propyl methacrylate was introduced to this polymerization system. The continuous dripping of the ascorbic acid solution was continued until 98% by weight of the total amount of the (meth)acrylic ester monomer mixture introduced to the polymerization system was consumed. Then, the dripping of the ascorbic acid solution was terminated, and the polymerization was finished.

The solvent was devolatilized after the jacket temperature was changed to 80° C. For the devolatilization, a diaphragm pump was used first, and then a vacuum pump was used. After completion of the devolatilization, the jacket temperature was cooled down to 60° C. or less.

(Purification)

To a stirring device with jacket temperature control, 1000 g of butyl acetate was introduced, and was mixed with the polymer after devolatilization and stirred until a homogeneous solution was obtained. To this homogeneous solution, an adsorbent was added and stirred for 1 hour. As the adsorbent, 10 g of KYOWAAD 500SH (available from Kyowa Chemical Industry Co., Ltd.) and 10 g of KYOWAAD 700SEN-S(available from Kyowa Chemical Industry Co., Ltd.) were used.

After completion of the stirring, a resultant mixture was filtered through a filter in which a bag filter cloth was laid. Thus, a clear polymer solution was obtained. To this solution was added 1.5 g of an antioxidant (SumilizerGS; available from Sumitomo Chemical Company, Limited) dissolved in approximately 20 g of butyl acetate, and mixed to become uniform. After that, the solvent was devolatilized from the solution to obtain a (meth)acrylic-based copolymer (A′)-1. For the devolatilization, a diaphragm pump was used first, and then a vacuum pump was used.

### Production Example 2: Production of (Meth)Acrylic-Based Copolymer (A′)-1

A polymer was produced by a procedure similar to that in Production Example 1, except that a composition of raw material monomers was changed to that indicated in Table 1. As the (meth)acrylic ester monomer mixture, 687 g of n-butyl acrylate, 104 g of ethyl acrylate, and 18.1 g of octadecyl acrylate (total: 997.2 g) were used. The polymer produced in Production Example 2 does not contain the (meth)acrylic ester monomer (α) as a raw material, and therefore corresponds to the (meth)acrylic-based copolymer (A′) but does not correspond to the (meth)acrylic-based copolymer (A″).

### Production Example 3: Production of (Meth)Acrylic-Based Copolymer (A′)-2

A polymer was produced by a procedure similar to that in Production Example 1, except that a composition of raw material monomers was changed to that indicated in Table 1. The (meth)acrylic ester monomer mixture used was identical with that used in Production Example 1. As the (meth)acrylic ester monomer having an alkoxysilyl group, 3-(dimethoxymethylsilyl)propyl methacrylate was used.

### Production Example 4: Production of (Meth)Acrylic-Based Copolymer (A′)-2

A polymer was produced by a procedure similar to that in Production Example 1, except that a composition of raw material monomers was changed to that indicated in Table 1. The (meth)acrylic ester monomer mixture used was identical with that used in Production Example 2. As the (meth)acrylic ester monomer having an alkoxysilyl group, 3-(dimethoxymethylsilyl)propyl methacrylate was used. The polymer produced in Production Example 4 does not contain the (meth)acrylic ester monomer (α) as a raw material, and therefore corresponds to the (meth)acrylic-based copolymer (A′) but (toes not correspond to the (meth)acrylic-based copolymer (A″).

TABLE 1

| | | | | Prod. Ex. 1 | Prod. Ex. 2 | Prod. Ex. 3 | Prod. Ex. 4 |
|---|---|---|---|---|---|---|---|
| | | Monomer type (carbon | | Copolymer | Copolymer | Copolymer | Copolymer |
| | | number) | Unit | (A″)-1 | (A′)-1 | (A″)-2 | (A′)-2 |
| Monomer | (Meth)acrylic | 2-methoxyethyl | Parts | 10.7 | — | 10.7 | — |
| composition | ester monomer | acrylate (C3*) | by | | | | |
| | (α) | | weight | | | | |
| | (Meth)acrylic | n-butyl acrylate (C4) | | 68.0 | 68.7 | 68.0 | 68.7 |
| | ester monomer | | | | | | |
| | (β) | | | | | | |
| | (Meth)acrylic | Ethyl acrylate | | — | 10.4 | — | 10.4 |
| | ester monomer | | | | | | |
| | (β) | | | | | | |
| | (Meth)acrylic | Octadecyl acrylate | | 18.5 | 18.1 | 18.5 | 18.1 |
| | ester monomer | (C18) | | | | | |
| | (δ) | | | | | | |
| | (Meth)acrylic | 3-(trimethoxysilyl) | | 2.8 | 2.8 | — | — |
| | ester monomer | propyl methacrylate | | | | | |
| | having | | | | | | |
| | alkoxysilyl group | | | | | | |
| | (Meth)acrylic | 3-(dimethoxymethylsilyl) | | — | — | 2.8 | 2.8 |
| | ester monomer | propyl methacrylate | | | | | |
| | having | | | | | | |
| | alkoxysilyl group | | | | | | |

| | | | | | |
|---|---|---|---|---|---|
| Total | — | 100 | 100 | 100 | 100 |

*Containing alkoxy group

### Physical Property Evaluation of Copolymer (Production Examples 1 and 2)

Physical properties of the (meth)acrylic-based copolymer (A″)-1 and the (meth)acrylic-based copolymer (A′)-1 obtained in Production Examples 1 and 2 were evaluated. Moreover, physical properties of a curable composition containing the copolymer and the polyoxyalkylene-based polymer (B) and a cured product obtained by curing the curable composition were also evaluated. In Table 2, evaluation items were measured with the following methods:

[Monomer Distribution]

(Distribution of Repeating Units Derived from (Meth)Acrylic Ester Monomer Having Alkoxysilyl Group)

Assuming that all (meth)acrylic ester monomers are incorporated into a polymer block at the same reaction rate, a distribution of repeating units derived from the (meth)acrylic ester monomer having an alkoxysilyl group (repeating units derived from 3-(trimethoxysilyl)propyl methacrylate) in the (meth)acrylic-based copolymer (A″) and the (meth)acrylic-based copolymer (A′) was derived. Specifically, the following three parameters were calculated with respect to the repeating units derived from 3-(trimethoxysilyl)propyl methacrylate. The results are shown in Table 2.

(a) The average number of the repeating units included in the X block.

(b) A weight ratio (% by weight) of the repeating units included in the X block to the entire polymer molecule.

(c) A weight ratio (% by weight) of the repeating units included in the Y block to the entire polymer molecule.

(Distribution of Repeating Units Derived from (Meth)Acrylic Ester Monomer (α))

In regard to the (meth)acrylic-based copolymer (A″), a weight ratio (% by weight) of repeating units derived from the (meth)acrylic ester monomer (α) (repeating units derived from 2-methoxyethyl acrylate) to the entire polymer molecule was calculated from a weight of introduced monomers and a consumption rate of the monomers (the results are shown in Table 2). According to the production method of Production Example 1 described above, the repeating units derived from 2-methoxyethyl acrylate are randomly distributed in the (meth)acrylic-based copolymer (A″).

[Evaluation of Copolymer]

(Molecular Weight and Molecular Weight Distribution)

A number-average molecular weight (Mn), a weight-average molecular weight (Mw), and a molecular weight distribution (Mw/Mn) of the copolymer were calculated by a standard polystyrene conversion method using gel permeation chromatography (GPC). As a column of GPC, a column (shodex GPC K-804; available from Showa Denko K.K.) filled with polystyrene crosslinked gel was used. Chloroform was used as a solvent for GPC. The results are shown in Table 2.

(Viscosity)

Viscosity of the copolymer was measured using a viscometer (VISCOMETER TV-25 available from Toki Sangyo Co., Ltd., 3°×R14 cone rotor, 1 rpm) at 23° C. The measurement was carried out in conformity to JIS K 7117-2. An amount of a sample used for the measurement was 0.4 mL. The results are shown in Table 2.

[Evaluation of Curable Composition]

The copolymer and the polyoxyalkylene-based polymer (B) were mixed to prepare a curable composition. As the polyoxyalkylene-based polymer (B), SAX220 (available from Kaneka Corporation) was used. A mixing ratio of the both components was set to 50:50 by weight ratio.

(Evaluation of Compatibility)

The copolymer and the polyoxyalkylene-based polymer (B) were stirred and mixed. After that, the curable composition was mixed and defoamed using a planetary stirring and mixing device (Awatori Rentaro, available from Thinky Corporation). Operating parameters of the device at the time of mixing were as follows, i.e., revolution: 1600 rpm, rotation: 640 rpm, and stirring time: 1.3 minutes. Operating parameters of the device at the time of defoaming were as follows, i.e., revolution: 2200 rpm, rotation: 60 rpm, and stirring time: 3 minutes. A resultant mixture was placed in a sample bottle and left to stand still for 2 hours in an oven at 60° C., and then a compatibilized state was observed. After that, the compatibilized state was observed also after the mixture was left at room temperature for another week. The results are shown in Table 2. In Table 2, “Good” represents that compatibility was seen in any of the conditions, and “Bad” represents that compatibility was not seen in at least one of the conditions.

(Evaluation of Viscosity)

Viscosity of the curable composition was measured using a viscometer (VISCOMETER TV-25 available from Toki Sangyo Co., Ltd., 3°×R14 cone rotor, 1 rpm) at 23° C. The measurement was carried out in conformity to JIS K 7117-2. An amount of a sample used for the measurement was 0.4 mL. The results are shown in Table 2.

[Evaluation of Cured Product]

To 100 parts by weight of the curable composition, a reactant of 2 parts by weight of tin octylate and 0.5 parts by weight of laurylamine was added, and the curable composition and the reactant were mixed sufficiently. A resultant mixture was poured into a mold and degassed under reduced pressure. After that, the degassed mixture was heated and cured at 50° C. for 20 hours to obtain a sheet-shaped cured product having rubber elasticity.

(Evaluation of Mechanical Properties)

A test piece having a dumbbell shape No. 3 specified in JIS K 7113 was punched out from the obtained sheet-shaped cured product. The test piece was subjected to a tensile test to measure mechanical properties. Specifically, stress at 50% elongation, stress at break, and elongation at break (elongation relative to a distance between chucks) were measured. The results are shown in Table 2. Note that Autograph (available from Shimadzu Corporation) was used for the measurement, and a measurement temperature was 23° C., and a tensile speed was 200 mm/min.

TABLE 2

| | | | | Prod. Ex. 1 | Prod. Ex. 2 |
|---|---|---|---|---|---|
| | | | | Copolymer | Copolymer |
| | | Remarks | Unit | (A″)-1 | (A′)-1 |
| Monomer | Block structure | — | — | XYX | XYX |
| distribution | Average number/contained | X block | piece/% by | 3.3/9.40 | 3.3/9.40 |
| | amount of repeating units | | weight | | |
| | derived from (meth)acrylic | Y block | % by weight | 0.17 | 0.17 |
| | ester monomer having | | | | |
| | alkoxysilyl group | | | | |
| | Contained amount of | — | % by weight | 10.70 | — |
| | repeating units derived | | | | |
| | from (meth)acrylic ester | | | | |
| | monomer (α) | | | | |
| | Distribution of repeating | — | — | Random | — |
| | units derived from | | | | |
| | (meth)acrylic ester | | | | |
| | monomer (α) | | | | |
| Evaluation | Molecular weight | — | Mn | 43000 | 45000 |
| result | | — | Mw | 49200 | 57000 |
| | Molecular weight | — | Mw/Mn | 1.14 | 1.3 |
| | distribution | | | | |
| | Viscosity | Copolymer | Pa · s (23° C.) | 160 | 290 |
| | | Curable | Pa · s (23° C.) | 50 | 60 |
| | | composition | | | |
| | Mechanical properties | Stress at 50% | MPa | 0.14 | 0.15 |
| | of cured product | elongation | | | |
| | | Stress at | MPa | 0.28 | 0.38 |
| | | break | | | |
| | | Elongation at | % | 150 | 170 |
| | | break | | | |
| | Compatibility with | — | — | Good | Good |
| | polyoxyalkylene- | | | | |
| | based polymer (B) | | | | |

[Results]

From Table 2, it can be seen that the (meth) acrylic-based copolymer (A″)-1 and the (meth)acrylic-based copolymer (A′)-1 exhibit physical properties substantially equivalent to those of a conventional copolymer, in terms of compatibility with the polyoxyalkylene-based polymer (B), viscosity of the curable composition, and mechanical properties of the cured product. In contrast, the viscosity (initial viscosity) of the copolymer immediately after production was remarkably lower in the (meth)acrylic-based copolymer (A″)-1 than in the (meth)acrylic-based copolymer (A′)-1. In other words, among the (meth)acrylic-based copolymers (A′), the (meth)acrylic-based copolymer (A″) in which a predetermined amount of repeating units derived from the (meth)acrylic ester monomer (α) are distributed has an advantage as a copolymer in that initial viscosity is low.

### Physical Property Evaluation of Copolymer (Production Examples 3 and 4)

Physical properties of the (meth)acrylic-based copolymer (A′)-2 and the (meth)acrylic-based copolymer (A′)-2 obtained in Production Examples 3 and 4 were evaluated. In addition, physical properties of cured products formed by curing the copolymers were also evaluated. Physical properties were evaluated with the methods as described above. Note, however, that, when the cured product was produced, only the (meth)acrylic-based copolymer (A″)-2 or the (meth)acrylic-based copolymer (A′)-2 was cured without blending the polyoxyalkylene-based polymer (B).

TABLE 3

| | | | | Prod. Ex. 3 | Prod. Ex. 4 |
|---|---|---|---|---|---|
| | | | | Copolymer | Copolymer |
| | | Remarks | Unit | (A″)-2 | (A′)-2 |
| Monomer | Block structure | — | — | XYX | XYX |
| distribution | Average number/contained | X block | piece/% by | 3.3/9.40 | 3.3/9.40 |
| | amount of repeating units | | weight | | |
| | derived from (meth)acrylic | Y block | % by weight | 0.17 | 0.17 |
| | ester monomer having | | | | |
| | alkoxysilyl group | | | | |
| | Contained amount of | — | % by weight | 10.70 | — |
| | repeating units derived | | | | |
| | from (meth)acrylic ester | | | | |
| | monomer (α) | | | | |
| | Distribution of repeating | — | — | Random | — |
| | units derived from | | | | |
| | (meth)acrylic ester | | | | |
| | monomer (α) | | | | |
| Evaluation | Molecular weight | — | Mn | 45000 | 43000 |
| result | | — | Mw | 51000 | 52000 |
| | Molecular weight | — | Mw/Mn | 1.13 | 1.21 |
| | distribution | | | | |
| | Viscosity | Copolymer | Pa · s (23° C.) | 160 | 280 |
| | Mechanical properties | Stress at 50% | MPa | 0.070 | 0.076 |
| | of cured product | elongation | | | |
| | | Stress at break | MPa | 0.20 | 0.25 |
| | | Elongation at | % | 160 | 170 |
| | | break | | | |
| | Compatibility with | — | — | Good | Good |
| | polyoxyalkylene- | | | | |
| | based polymer (B) | | | | |

From Table 3, it can be seen that the (meth)acrylic-based copolymer (A″)-2 and the (meth)acrylic-based copolymer (A′)-2 exhibit physical properties substantially equivalent to those of a conventional copolymer, in terms of compatibility with the polyoxyalkylene-based polymer (B) and mechanical properties of the cured product. In contrast, the viscosity (initial viscosity) of the copolymer immediately after production was remarkably lower in the (meth)acrylic-based copolymer (A″)-2 than in the (meth)acrylic-based copolymer (A′)-2. In other words, among the (meth)acrylic-based copolymers (A′), the (meth)acrylic-based copolymer (A″) in which a predetermined amount of repeating units derived from the (meth)acrylic ester monomer (α) are distributed has an advantage as a copolymer in that initial viscosity is low.

### Example 1-11

It was confirmed that an increase in viscosity after storage at a high temperature can be inhibited by adding the epoxy compound (C) to the (meth)acrylic-based copolymer (A″)-1 produced in Production Example 1. Specifically, in the purification step of Production Example 1, the epoxy compound (C) and 1.5 g (0.15 parts by weight) of an antioxidant (SumilizerGS) were added to the clear polymer solution obtained by filtration through the filter in which the bag filter cloth was laid. At this time, the epoxy compound (C) and the antioxidant were added in a state of being dissolved in approximately 20 g of butyl acetate. After that, the solution was mixed to become uniform, and the solvent was devolatilized to obtain a composition containing the (meth)acrylic-based copolymer (A″)-1 and the epoxy compound (C).

The mixing ratio between the (meth)acrylic-based copolymer (A″)-1 and the epoxy compound (C) is as shown in Table 4.

A resultant composition (10 mL) was placed in a vial bottle and left to stand still in a constant temperature bath at 80° C. Viscosity was measured using a viscometer (VISCOMETER TV-25 available from Toki Sangyo Co., Ltd., 3°×R14 cone rotor, 1 rpm) at 23° C. The measurement was carried out in conformity to JIS K 7117-2. An amount of a sample used for the measurement was 0.4 mL. The results are shown in Table 4.

### Examples 1-2 Through 1-4

It was confirmed that an increase in viscosity after storage at a high temperature can be inhibited by adding the epoxy compound (C) to the (meth)acrylic-based copolymer (A′)-1 produced in Production Example 2. Specifically, a composition containing the (meth)acrylic-based copolymer (A′)-1 and the epoxy compound (C) was prepared by a procedure similar to that in Example 1-1 (a type and a mixing ratio of the epoxy compound (C) used are as shown in Table 4). Then, an increase in viscosity under the high temperature condition of this composition was tracked. The results are shown in Table 4.

### Comparative Example 1-11

The (meth)acrylic-based copolymer (A′)-1 was stored under conditions similar to those in Examples 1-2 through 1-4, except that no epoxy compound (C) was added, and an increase in viscosity under the high temperature condition was tracked. The results are shown in Table 4.

TABLE 4

| | | Remarks | Ex. 1-1 | Ex. 1-2 | Ex. 1-3 | Ex. 1-4 | Com. Ex. 1-1 |
|---|---|---|---|---|---|---|---|
| Type of (meth)acrylic-based | | — | (A″)-1 | (A′)-1 | (A′)-1 | (A′)-1 | (A′)-1 |
| copolymer | | | | | | | |
| Contained | Copolymer | — | 100 | 100 | 100 | 100 | 100 |
| amount (parts by | Epoxy | Epoxidized soybean oil | — | 0.57 | — | — | — |
| weight/molar | compound | (SANSO CIZER | | (0.21) | | | |
| ratio**) | (C) | E-2000H) | | | | | |
| | | Epoxy plasticizer | 3.0 | — | 1.23 | — | — |
| | | (SANSO CIZER E-PS) | (2.3) | | (1.0) | | |
| | | Monoepoxide (Epolite | — | — | — | 0.75 | — |
| | | M1230) | | | | (1.0) | |
| Evaluation result | Viscosity | Initial viscosity* | 157.3 | 293.3 | 291.8 | 285.9 | 287.9 |
| | (Pa · s) and | 80° C./viscosity after | 157.9 | 296.2 | 309.5 | 310.0 | Gelation |
| | viscosity | 1 week | | | | | |
| | increase | 80° C./viscosity | 0.38 | 0.99 | 6.06 | 8.43 | — |
| | ratio (%) | increase ratio after | | | | | |
| | | 1 week | | | | | |
| | | 80° C./viscosity after | 163.8 | 324.6 | 330.9 | 352.4 | — |
| | | 2 weeks | | | | | |
| | | 80° C./viscosity | 4.13 | 10.67 | 13.40 | 23.26 | — |
| | | increase ratio after | | | | | |
| | | 2 weeks | | | | | |
| | | 80° C./viscosity after | 175.6 | 428.2 | 400.0 | 458.4 | — |
| | | 4 weeks | | | | | |
| | | 80° C./viscosity | 11.63 | 45.99 | 37.08 | 60.34 | — |
| | | increase ratio after | | | | | |
| | | 4 weeks | | | | | |

*Viscosity immediately before standing still in constant temperature bath
**Molar equal quantity with respect to halogen atoms contained in copolymer

[Results]

As can be seen from Example 1-1, by adding the epoxy compound (C) to the (meth)acrylic-based copolymer (A″)-1, the stability after storage at the high temperature was improved. In addition, as can be seen from Examples 1-2 through 1-4, by adding the epoxy compound (C) to the (meth)acrylic-based copolymer (A′)-1 also, the stability after storage at the high temperature was improved. In contrast, as can be seen from Comparative Example 1, when no epoxy compound (C) was added, the (meth)acrylic-based copolymer (A′)-1 gelated in 1 week from the start of storage. From these results, it is suggested that the addition of the epoxy compound (C) generally inhibits an increase in storage viscosity of the (meth)acrylic-based copolymer (A″) and the (meth)acrylic-based copolymer (A′).

### Examples 2-1 Through 2-5

It was confirmed that an increase in viscosity after storage at a high temperature can be inhibited by adding the epoxy compound (C) to the (meth)acrylic-based copolymer (A″)-2 produced in Production Example 3. Specifically, in the purification step of Production Example 3, the epoxy compound (C) and 1.5 g of an antioxidant (SumilizerGS) were added to the clear polymer solution obtained by filtration through the filter in which the bag filter cloth was laid. At this time, the epoxy compound (C) and the antioxidant were added in a state of being dissolved in approximately 20 g of butyl acetate. After that, the solution was mixed to become uniform, and the solvent was devolatilized to obtain a composition containing the (meth)acrylic-based copolymer (A″)-2 and the epoxy compound (C).

The mixing ratio between the (meth)acrylic-based copolymer (A″)-2 and the epoxy compound (C) is as shown in Table 5.

A resultant composition (10 mL) was placed in a vial bottle and left to stand still in a constant temperature bath at 80° C. Viscosity was measured using a viscometer (VISCOMETER TV-25 available from Toki Sangyo Co., Ltd., 3°×R14 cone rotor, 1 rpm) at 23° C. The measurement was carried out in conformity to JIS K 7117-2. An amount of a sample used for the measurement was 0.4 mL. The results are shown in Table 5.

Moreover, a gel fraction of the composition immediately after the obtainment was measured. Specifically, the obtained composition was immersed in toluene and kept at 23° C. for 24 hours. After that, the gel fraction was calculated according to the following equation.

Gel fraction (%)=(weight of solid component left undissolved+weight of composition prior to immersion in toluene)×100.

Further, to 100 parts by weight of the composition, a reactant of 2 parts by weight of tin octylate and 0.5 parts by weight of laurylamine was added and mixed sufficiently (note that the polyoxyalkylene-based resin (B) was not contained in this composition). A resultant mixture was poured into a mold and degassed under reduced pressure. After that, the degassed mixture was heated and cured at 50° C. for 20 hours to obtain a sheet-shaped cured product having rubber elasticity. A test piece having a dumbbell shape No. 3 specified in JIS K7113 was punched out from the obtained sheet-shaped cured product. The test piece was subjected to a tensile test to measure mechanical properties. Specifically, stress at 50% elongation, stress at 100% elongation, stress at break, and elongation at break (elongation relative to a distance between chucks) were measured. The results are shown in Table 5. Note that Autograph (available from Shimadzu Corporation) was used for the measurement, and a measurement temperature was 23° C., and a tensile speed was 200 mm/min.

### Comparative Example 2-11

The (meth)acrylic-based copolymer (A″)-2 was stored under conditions similar to those in Examples 2-1 through 2-5, except that the epoxy compound (C) and an antioxidant were not added to the (meth)acrylic-based copolymer (A″)-2 produced in Production Example 3, and an increase in viscosity under the high temperature condition was tracked. In addition, as in Examples 2-1 through 2-5, the gel fraction of the composition and the mechanical properties of the cured product were also measured. The results are shown in Table 5.

### Comparative Example 2-2

The (meth)acrylic-based copolymer (A″)-2 was stored under conditions similar to those in Examples 2-1 through 2-5, except that the epoxy compound (C) was not added to the (meth)acrylic-based copolymer (A″)-2 produced in Production Example 3, and an increase in viscosity under the high temperature condition was tracked. In addition, as in Examples 2-1 through 2-5, the gel fraction of the composition and the mechanical properties of the cured product were also measured. The results are shown in Table 5.

### Examples 2-6 Through 2-8

It was confirmed that an increase in viscosity after storage at a high temperature can be inhibited by adding the epoxy compound (C) to the (meth)acrylic-based copolymer (A′)-2 produced in Production Example 4. Specifically, a composition containing the (meth)acrylic-based copolymer (A′)-2 and the epoxy compound (C) was prepared by a procedure similar to that in Examples 2-1 through 2-5 (a type and a mixing ratio of the epoxy compound (C) used are as shown in Table 5). Then, an increase in viscosity under the high temperature condition of this composition was tracked. In addition, as in Examples 2-1 through 2-5, the gel fraction of the curable composition and the mechanical properties of the cured product were also measured. The results are shown in Table 5.

### Comparative Example 2-31

The (meth)acrylic-based copolymer (A′)-2 was stored under conditions similar to those in Examples 2-6 through 2-8, except that the epoxy compound (C) was not added to the (meth)acrylic-based copolymer (A′)-2 produced in Production Example 4, and an increase in viscosity under the high temperature condition was tracked. In addition, as in Examples 2-1 through 2-5, the gel fraction of the curable composition and the mechanical properties of the cured product were also measured. The results are shown in Table 5.

TABLE 5

| | | | Ex. | Ex. | Ex. | Ex. | Ex. | Com. |
|---|---|---|---|---|---|---|---|---|
| | | Remarks | 2-1 | 2-2 | 2-3 | 2-4 | 2-5 | Ex. 2-1 |
| Type of (meth)acrylic-based | | — | (A″)-2 | (A″)-2 | (A″)-2 | (A″)-2 | (A″)-2 | (A″)-2 |
| copolymer | | | | | | | | |
| Contained | Copolymer | — | 100 | 100 | 100 | 100 | 100 | 100 |
| amount (parts | Epoxy | Epoxy plasticizer | 3 | — | — | — | — | — |
| by weight/ | compound | (SANSO CIZER | (3.2) | | | | | |
| molar ratio**) | (C) | E-PS) | | | | | | |
| | | Epoxidized | — | 6 | 0.5 | — | — | — |
| | | soybean oil | | (14.5) | (1.2) | | | |
| | | (SANSO CIZER | | | | | | |
| | | E-2000H) | | | | | | |
| | | Epoxidized linseed | — | — | — | 6 | 0.5 | — |
| | | oil (SANSO CIZER | | | | (16.8) | (1.4) | |
| | | E-9000H) | | | | | | |
| Evaluation | Viscosity | Initial viscosity* | 165.1 | 148.2 | 197.3 | 148.7 | 196.9 | 195.0 |
| result | (Pa · s) and | 80° C./viscosity | 167.3 | 145.0 | 197.1 | 150.5 | 197.6 | Gelation |
| | viscosity | after 1 week | | | | | | |
| | increase | 80° C./viscosity | 1.33 | −2.16 | −0.10 | 1.21 | 0.36 | — |
| | ratio (%) | increase ratio | | | | | | |
| | | after 1 week | | | | | | |
| | | 80° C./viscosity | 170.1 | 146.7 | 202.5 | 154 | 204.4 | — |
| | | after 2 weeks | | | | | | |
| | | 80° C./viscosity | 3.03 | −1.01 | 2.64 | 3.56 | 3.81 | — |
| | | increase ratio | | | | | | |
| | | after 2 weeks | | | | | | |
| | | 80° C./viscosity | 174.2 | 149.7 | 202.5 | 157.1 | 205.9 | — |
| | | after 4 weeks | | | | | | |
| | | 80° C./viscosity | 5.51 | 1.01 | 2.64 | 5.65 | 4.57 | — |
| | | increase ratio | | | | | | |
| | | after 4 weeks | | | | | | |
| Type of (meth)acrylic-based | | — | (A″)-2 | (A″)-2 | (A″)-2 | (A″)-2 | (A″)-2 | (A″)-2 |
| copolymer | | | | | | | | |
| Contained | Copolymer | — | 100 | 100 | 100 | 100 | 100 | 100 |
| amount | Epoxy | Epoxy plasticizer | 3 | — | — | — | — | — |
| (parts by | compound | (SANSO CIZER | (3.2) | | | | | |
| weight/molar | (C) | E-PS) | | | | | | |
| ratio**) | | Epoxidized soybean | — | 6 | 0.5 | — | — | — |
| | | oil (SANSO CIZER | | (14.5) | (1.2) | | | |
| | | E-2000H) | | | | | | |
| | | Epoxidized linseed | — | — | — | 6 | 0.5 | — |
| | | oil (SANSO CIZER | | | | (16.8) | (1.4) | |
| | | E-9000H) | | | | | | |
| Evaluation | Mechanical | Stress at 50% | 0.084 | 0.082 | 0.10 | 0.083 | 0.097 | 0.090 |
| result | strength | elongation (MPa) | | | | | | |
| | | Stress at 100% | 0.14 | 0.14 | 0.18 | 0.14 | 0.16 | 0.16 |
| | | elongation (MPa) | | | | | | |
| | | Stress at break | 0.20 | 0.19 | 0.24 | 0.21 | 0.23 | 0.24 |
| | | (MPa) | | | | | | |
| | | Elongation at | 139 | 136 | 138 | 146 | 141 | 148 |
| | | break (%) | | | | | | |
| | | Gel fraction (%) | 94 | 92 | 97 | 92 | 97 | 95 |

| | | | Com. | Ex. | Ex. | Ex. | Com. |
|---|---|---|---|---|---|---|---|
| | | Remarks | Ex. 2-2 | 2-6 | 2-7 | 2-8 | Ex. 2-3 |
| Type of (meth)acrylic-based | | — | (A″)-2 | (A′)-2 | (A′)-2 | (A′)-2 | (A′)-2 |
| copolymer | | | | | | | |
| Contained | Copolymer | — | 100 | 100 | 100 | 100 | 100 |
| amount (parts | Epoxy | Epoxy plasticizer | — | — | — | — | — |
| by weight/ | compound | (SANSO CIZER | | | | | |
| molar ratio**) | (C) | E-PS) | | | | | |
| | | Epoxidized | — | 0.6 | 0.15 | 0.06 | — |
| | | soybean oil | | (1.4) | (0.4) | (0.1) | |
| | | (SANSO CIZER | | | | | |
| | | E-2000H) | | | | | |
| | | Epoxidized linseed | — | — | — | — | — |
| | | oil (SANSO CIZER | | | | | |
| | | E-9000H) | | | | | |
| Evaluation | Viscosity | Initial viscosity* | 189.6 | 293.3 | 300.2 | 304.0 | 310.9 |
| result | (Pa · s) and | 80° C./viscosity | 647.0 | 296.2 | 303.8 | 308.8 | 526.0 |
| | viscosity | after 1 week | | | | | |
| | increase | 80° C./viscosity | 241.24 | 0.99 | 1.20 | 1.58 | 69.19 |
| | ratio (%) | increase ratio | | | | | |
| | | after 1 week | | | | | |
| | | 80° C./viscosity | Gelation | 324.6 | 330.2 | 337.4 | Gelation |
| | | after 2 weeks | | | | | |
| | | 80° C./viscosity | — | 10.67 | 9.99 | 10.99 | — |
| | | increase ratio | | | | | |
| | | after 2 weeks | | | | | |
| | | 80° C./viscosity | — | Not | Not | Not | — |
| | | after 4 weeks | | measured | measured | measured | |
| | | 80° C./viscosity | — | — | — | — | — |
| | | increase ratio | | | | | |
| | | after 4 weeks | | | | | |
| Type of (meth)acrylic-based | | — | (A″)-2 | (A′)-2 | (A′)-2 | (A′)-2 | (A′)-2 |
| copolymer | | | | | | | |
| Contained | Copolymer | — | 100 | 100 | 100 | 100 | 100 |
| amount | Epoxy | Epoxy plasticizer | — | — | — | — | — |
| (parts by | compound | (SANSO CIZER E- | | | | | |
| weight/molar | (C) | PS) | | | | | |
| ratio**) | | Epoxidized soybean | — | 0.6 | 0.15 | 0.06 | — |
| | | oil (SANSO CIZER | | (1.4) | (0.4) | (0.1) | |
| | | E-2000H) | | | | | |
| | | Epoxidized linseed | — | — | — | — | — |
| | | oil (SANSO CIZER | | | | | |
| | | E-9000H) | | | | | |
| Evaluation | Mechanical | Stress at 50% | 0.094 | 0.094 | 0.073 | 0.10 | 0.077 |
| result | strength | elongation (MPa) | | | | | |
| | | Stress at 100% | 0.16 | 0.16 | 0.11 | 0.18 | 0.12 |
| | | elongation (MPa) | | | | | |
| | | Stress at break | 0.23 | 0.23 | 0.23 | 0.24 | 0.20 |
| | | (MPa) | | | | | |
| | | Elongation at | 139 | 139 | 201 | 138 | 179 |
| | | break (%) | | | | | |
| | | Gel fraction (%) | 95 | 95 | 93 | 97 | 92 |

*Viscosity immediately before standing still in constant temperature bath
**Molar equal quantity with respect to halogen atoms contained in copolymer

[Results]

As can be seen from Examples 2-1 through 2-5, by adding the epoxy compound (C) to the (meth)acrylic-based copolymer (A″)-2, the stability after storage at the high temperature was improved. In addition, as can be seen from Examples 2-6 through 2-8, by adding the epoxy compound (C) to the (meth)acrylic-based copolymer (A′)-2 also, the stability after storage at the high temperature was improved. In particular, Example 2-8 shows that, even when the amount of the epoxy compound (C) added is small (i.e., 0.06 parts by weight), the effect of lowering viscosity is brought about. In contrast, as can be seen from Comparative Examples 2-1 through 2-3, when no epoxy compound (C) was added, the (meth)acrylic-based copolymer (A′)-2 or the (meth)acrylic-based copolymer (A′)-2 gelated in 1 to 2 weeks from the start of storage. From these results, it is suggested that the addition of the epoxy compound (C) generally inhibits an increase in storage viscosity of the (meth)acrylic-based copolymer (A″) and the (meth)acrylic-based copolymer (A′).

Further, when Example 2-2 is compared with Example 2-3, and Example 2-4 is compared with Example 2-5, the mechanical properties of the cured product tend to be better in the cases where the amount of the epoxy compound (C) added is smaller. In contrast, when Examples 2-6 through 2-8 are compared, the mechanical properties of the curable composition are not good even in the cases where the amount of the epoxy compound (C) added is reduced. From those results, it is suggested that the amount of the epoxy compound (C) added may be approximately 0.5 parts by weight (e.g., 0.3 parts by weight to 1 part by weight) with respect to 100 parts by weight of the (meth)acrylic-based copolymer (A′) and/or the (meth)acrylic-based copolymer (A″), from the viewpoint of mechanical strength.

### INDUSTRIAL APPLICABILITY

One or more embodiments of the present invention are applicable to a sealing material, an adhesive agent, and the like.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A composition comprising:
a (meth)acrylic-based copolymer (A′); and
an epoxy compound (C),
wherein:
the (meth)acrylic-based copolymer (A′) has an X block and a Y block;
a molecule of the (meth)acrylic-based copolymer (A′) includes an XY diblock structure or an XYX triblock structure therein;
a number of repeating units which are derived from a (meth)acrylic ester monomer having an alkoxysilyl group and are included in the X block is 1.0 or more on average;
an amount of repeating units which are derived from a (meth)acrylic ester monomer having an alkoxysilyl group and are included in the Y block is 0% by weight to 3% by weight, with respect to a weight of all repeating units included in the Y block; and
a molecular weight distribution (Mw/Mn) of the (meth)acrylic-based copolymer (A′) is 1.8 or less.

2. The composition as set forth in claim 1, wherein the (meth)acrylic-based copolymer (A′) is a (meth)acrylic-based copolymer (A′) that satisfies the following conditions:
the (meth)acrylic-based copolymer (A″) randomly includes repeating units derived from a (meth)acrylic ester monomer (α);
the (meth)acrylic ester monomer (α) has an alkyl group that is coupled to (meth)acrylic acid via an ester bond, and the alkyl group has an alkoxy group having 1 to 5 carbon atoms; and
the repeating units derived from the (meth)acrylic ester monomer (α) are included in an amount of 5% by weight to 20% by weight, with respect to a weight of all repeating units included in the (meth)acrylic-based copolymer (A″).

3. The composition as set forth in claim 2, wherein the (meth)acrylic ester monomer (α) is one or more selected from the group consisting of 2-methoxyethyl (meth)acrylate, 2-ethoxyethyl (meth)acrylate, 2-butoxyethyl (meth)acrylate, and isopropoxyethyl (meth)acrylate.

4. The composition as set forth in claim 1, wherein an amount of the repeating units which are derived from the (meth)acrylic ester monomer having the alkoxysilyl group and are included in the X block is more than 3% by weight, with respect to a weight of all repeating units included in the X block.

5. The composition as set forth in claim 1, wherein:
the (meth)acrylic-based copolymer (A′) includes repeating units derived from a (meth)acrylic ester monomer (β) and a (meth)acrylic acid monomer (γ) in a total amount of 45% by weight to 96% by weight, and repeating units derived from a (meth)acrylic ester monomer (δ) in an amount of 4% by weight to 35% by weight, with respect to a weight of all repeating units;
in the (meth)acrylic ester monomer (β), a number of carbon atoms of an alkyl group coupled to (meth)acrylic acid via an ester bond is 1 to 5;
in the (meth)acrylic ester monomer (γ), a number of carbon atoms of an alkyl group coupled to (meth)acrylic acid via an ester bond is 6 to 15; and
in the (meth)acrylic ester monomer (δ), a number of carbon atoms of alkyl coupled to (meth)acrylic acid via an ester bond is 16 to 25.

6. The composition as set forth in claim 5, wherein the (meth)acrylic ester monomer (δ) is one or more selected from the group consisting of pentadecyl (meth)acrylate, hexadecyl (meth)acrylate, heptadecyl (meth)acrylate, octadecyl (meth)acrylate, icosyl (meth)acrylate, and docosyl (meth)acrylate.

7. The composition as set forth in claim 1, wherein:
a contained amount of the (meth)acrylic-based copolymer (A′) and/or the (meth)acrylic-based copolymer (A″) is 50% by weight to 99.9% by weight; and
a contained amount of the epoxy compound (C) is 0.1% by weight to 50% by weight.

8. The composition as set forth claim 1, wherein the epoxy compound (C) is one or more selected from the group consisting of epoxidized unsaturated fats and oils, an epoxy plasticizer, and monoepoxide.

9. A curable composition, comprising:
the composition recited in claim 1; and
a polyoxyalkylene-based polymer (B) having an alkoxysilyl group.

10. A cured product which is obtained by curing the composition recited in claim 1.

11. A cured product which is obtained by curing the curable composition recited in claim 9.

12. A sealing material or an adhesive agent, comprising the composition recited in claim 1.

13. A sealing material or an adhesive agent, comprising the curable composition recited in claim 9.

14. A sealing material or an adhesive agent, comprising the cured product recited in claim 10.

15. A method for storing a (meth)acrylic-based copolymer (A′) and/or a (meth)acrylic-based copolymer (A″), the method comprising a step of preparing the composition recited in claim 1, wherein:
a contained amount of the (meth)acrylic-based copolymer (A′) and/or the (meth)acrylic-based copolymer (A″) in the composition is 50% by weight to 99.9% by weight; and
a contained amount of the epoxy compound (C) in the composition is 0.1% by weight to 50% by weight.

16. The method as set forth in claim 15, wherein a viscosity increase ratio of the composition is 65% or less, after storage for 4 weeks at 80° C.

17. A method for producing the composition recited in claim 1, the method comprising a step 1a, a step 2a, and a step 3a, or comprising a step 1b, a step 2b, and a step 3b, wherein:
the step 1a is a step of polymerizing a (meth)acrylic ester monomer mixture with a living polymerization initiator, the (meth)acrylic ester monomer mixture containing more than 3% by weight of the (meth)acrylic ester monomer having the alkoxysilyl group;
the step 2a is a step of adding, to a reaction system after the step 1a, a (meth)acrylic ester monomer mixture containing 0% by weight to 3% by weight of the (meth)acrylic ester monomer having the alkoxysilyl group, and polymerizing the reaction system;
the step 3a is a step of mixing the epoxy compound (C) with the (meth)acrylic-based copolymer (A′) which has been obtained through the step 2a and an optionally added polymerization process;
the step 1b is a step of polymerizing a (meth)acrylic ester monomer mixture with a living polymerization initiator, the (meth)acrylic ester monomer mixture containing 0% by weight to 3% by weight of the (meth)acrylic ester monomer having the alkoxysilyl group;
the step 2b is a step of adding, to a reaction system after the step 1b, a (meth)acrylic ester monomer mixture containing more than 3% by weight of the (meth)acrylic ester monomer having the alkoxysilyl group, and polymerizing the reaction system; and
the step 3b is a step of mixing the epoxy compound (C) with the (meth)acrylic-based copolymer (A′) which has been obtained through the step 2b and an optionally added polymerization process.

18. The method as set forth in claim 17, wherein the living polymerization initiator is a living radical polymerization initiator.
